(19) United States
(12) Patent Application Publication
(10) Pub. No.: US 2024/0328146 A1
(43) Pub. Date: Oct. 3, 2024

(54) APPARATUS AND METHODS FOR A PORTABLE AUTONOMOUS STORE

(71) Applicant: Gilbarco Inc., Greensboro, NC (US)

(72) Inventors: Barak MEIRI, Kadima-Zuran (IL); Abigail Marie MCKELLAR, Somerset (GB); Michael SEEGER, Knoxville, TN (US); Stephen W. LIGUORI, Chapel Hill, NC (US); Hayden DOWNEY, Erie, PA (US); Joseph Daniel NASON, JR., Fairview, PA (US); Graham Hendrickson VICKERY, Erie, PA (US); Anthony Joseph RAY, SR., Erie, PA (US); Jason T. DAVIS, Cambridge Springs, PA (US)

(21) Appl. No.: 18/624,966

(22) Filed: Apr. 2, 2024

Related U.S. Application Data
(60) Provisional application No. 63/456,509, filed on Apr. 2, 2023.

(51) Int. Cl. E04B 1/343; E04H 1/12

(52) U.S. Cl. CPC E04B 1/34384; E04B 1/34321; E04H 1/1205

(57) ABSTRACT

A method and apparatus for a portable building structure may include a plurality of interior attachment points, including a first portion to secure equipment to an interior of the portable building structure when the equipment is in use, and a second portion to secure the equipment to the interior portion of the portable building structure during transportation of the portable building structure. A plurality of exterior attachment points may be included, which may include a first portion to enable the portable building structure to be lifted off the ground prior to transportation, and a second portion to enable the portable building structure to be secured to a vehicle for transportation. A computing device may be included to track at least one user within the portable building structure and determine whether the at least one user has taken an object from a first location and placed it in a second location.

### RELATED CASES

This application claims the benefit of U.S. Provisional Application No. 63/456,509, filed on 2 Apr. 2023, the contents of which are all incorporated by reference.

### BACKGROUND

Stores (or other structures) make life easier for consumers by enabling them to purchase certain items as needed. The need for stores may arise from the evolving nature of consumer behavior and the dynamic nature of urban development. Cities and neighborhoods experience fluctuations in population density, demographics, and economic activities over time. As a result, the demand for retail services, including stores (e.g., convenience stores) may vary in different areas and at different times.

### SUMMARY

In one example implementation, a portable building structure may include but is not limited to a plurality of interior attachment points that may include a first portion of the plurality of interior attachment points configured to secure equipment to an interior portion of the portable building structure when the equipment is in use, and a second portion of the plurality of interior attachment points configured to further secure the equipment to the interior portion of the portable building structure during transportation of the portable building structure. The portable building structure may further include a plurality of exterior attachment points that may include a first portion of the plurality of exterior attachment points configured to enable the portable building structure to be lifted off a ground surface prior to transportation, and a second portion of the plurality of exterior attachment points configured to enable the portable building structure to be secured to a vehicle for transportation. The portable building structure may further include a computing device configured to track at least one user within the portable building structure, wherein the computing device is further configured to determine whether the at least one user has taken an object from a first location within the portable building structure and placed it in a second location within the portable building structure.

One or more of the following example features may be included. The first portion of the plurality of interior attachment points configured to secure the equipment to the interior portion of the portable building structure when the equipment is in use may include at least one of a plurality of barriers extending from at least one wall of the portable building structure and at least one channel securing a portion of the equipment to the at least one wall of the portable building structure. The second portion of the plurality of interior attachment points configured to further secure the equipment to the interior portion of the portable building structure during transportation of the portable building structure may include at least one channel securing a portion of the equipment to at least one wall of the portable building structure. The first portion of the plurality of exterior attachment points configured to enable the portable building structure to be lifted off the ground surface prior to transportation may include one or more lift attachments. The second portion of the plurality of exterior attachment points configured to enable the portable building structure to be secured to the vehicle for transportation may include one or more rings. The one or more rings may enable the portable building structure to be secured to the vehicle for transportation without extending beyond a perimeter of the portable building structure. The portable building structure may further include one or more interior channels for receiving electrical wiring, wherein the one or more interior channels may be coupled to a front frame of the portable building structure.

In another example implementation, a portable building structure may include but is not limited to a plurality of interior attachment points that may include a first portion of the plurality of interior attachment points configured to secure equipment to an interior portion of the portable building structure when the equipment is in use, and a second portion of the plurality of interior attachment points configured to further secure the equipment to the interior portion of the portable building structure during transportation of the portable building structure. The second portion of the plurality of interior attachment points configured to further secure the equipment to the interior portion of the portable building structure during transportation of the portable building structure may include at least one channel securing a portion of the equipment to at least one wall of the portable building structure. The portable building structure may further include a plurality of exterior attachment points that may include a first portion of the plurality of exterior attachment points configured to enable the portable building structure to be lifted off a ground surface prior to transportation, and a second portion of the plurality of exterior attachment points configured to enable the portable building structure to be secured to a vehicle for transportation.

One or more of the following example features may be included. The first portion of the plurality of interior attachment points configured to secure the equipment to the interior portion of the portable building structure when the equipment is in use may include at least one of a plurality of barriers extending from at least one wall of the portable building structure and at least one channel securing a portion of the equipment to the at least one wall of the portable building structure. The portable building structure may further include a computing device configured to track at least one user within the portable building structure, wherein the computing device is further configured to determine whether the at least one user has taken an object from a first location within the portable building structure and placed it in a second location within the portable building structure. The first portion of the plurality of exterior attachment points configured to enable the portable building structure to be lifted off the ground surface prior to transportation may include one or more lift attachments. The second portion of the plurality of exterior attachment points configured to enable the portable building structure to be secured to the vehicle for transportation may include one or more rings. The one or more rings may enable the portable building structure to be secured to the vehicle for transportation without extending beyond a perimeter of the portable building structure. The portable building structure may further include one or more interior channels for receiving electrical wiring, wherein the one or more interior channels may be coupled to a front frame of the portable building structure.

In another example implementation, method may include but is not limited to securing, using a first portion of a plurality of interior attachment points, equipment to an interior portion of a portable building structure. The equipment may be secured, using a second portion of the plurality of interior attachment points, to the interior portion of the portable building structure for transportation of the portable building structure. The portable building structure may be enabled, using a first portion of a plurality of exterior attachment points, to be lifted off a ground surface prior to transportation. The portable building structure may be enabled, using a second portion of a plurality of exterior attachment points, to be secured to a vehicle for transportation. A computing device tracking system may be installed to track at least one user within the portable building structure and to determine whether the at least one user has taken an object from a first location within the portable building structure and placed it in a second location within the portable building structure.

One or more of the following example features may be included. Securing the equipment to the interior portion of the portable building structure may include securing the equipment to the interior portion of the portable building structure using at least one of a plurality of barriers extending from at least one wall of the portable building structure and at least one channel securing a portion of the equipment to the at least one wall of the portable building structure. One or more lift attachments may be used to enable the portable building structure to be lifted off the ground surface prior to transportation. Securing the equipment to the interior portion of the portable building structure for transportation of the portable building structure may include securing, using at least one channel, a portion of the equipment to at least one wall of the portable building structure. One or more rings of the second portion of the plurality of exterior attachment points may be used to secure the portable building structure to the vehicle for transportation. The one or more rings may enable the portable building structure to be secured to the vehicle for transportation without extending beyond a perimeter of the portable building structure. A front frame of the portable building structure may be coupled to one or more interior channels for receiving electrical wiring.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF DRAWINGS

FIG. 1 is an example diagrammatic view of an Autonomous Store Process (ASP) coupled to an example distributed computing network according to one or more example implementations of the disclosure;

FIG. 2 is an example diagrammatic view of a client electronic device of FIG. 1 according to one or more example implementations of the disclosure;

FIG. 3 is an example flowchart of an ASP according to one or more example implementations of the disclosure;

FIG. 4 is an example diagrammatic and isometric view of a portable store according to one or more example implementations of the disclosure;

FIG. 5 is an example diagrammatic view of an entry system according to one or more example implementations of the disclosure;

FIGS. 6, 9 and 10 are example diagrammatic and top views of an interior of a portable store according to one or more example implementations of the disclosure;

FIG. 7 is an example diagrammatic and top view of an exterior of a portable store according to one or more example implementations of the disclosure;

FIGS. 8 and 11 are example diagrammatic and plan views of a cross-section of a wall of a portable store according to one or more example implementations of the disclosure;

FIG. 12 is an example flowchart of an ASP according to one or more example implementations of the disclosure;

FIG. 13 is an example diagrammatic view of a data structure used by an ASP according to one or more example implementations of the disclosure; and

FIG. 14 is an example diagrammatic view of a portable store according to one or more example implementations of the disclosure.

Like reference symbols in the various drawings may indicate like elements.

### DESCRIPTION

### System Overview:

Stores (or other structures) make life easier for consumers by enabling them to purchase certain items as needed. The need for stores may arise from the evolving nature of consumer behavior and the dynamic nature of urban development. Cities and neighborhoods experience fluctuations in population density, demographics, and economic activities over time. As a result, the demand for retail services, including stores (e.g., convenience stores) may vary in different areas and at different times. Traditional stores are typically fixed structures located in specific geographic locations, limiting their ability to adapt to changing consumer trends, local demands, or market dynamics. Therefore, as will be discussed in greater detail below, a portable store using unique designs and constructions may help address these example and non-limiting issues, allowing such stores to be easily moved from one location to another.

Moreover, autonomous (e.g., unattended and cashierless) environments (e.g., stores) may offer a type of retail experience that differs greatly from the traditional experience. For instance, an autonomous environment, such as a store, may rely on advanced technologies such as artificial intelligence, computer vision, and machine learning to allow customers to, e.g., enter, browse, and/or purchase items without any human interaction. That is, an autonomous environment may be generally defined as an environment (e.g., store) fitted with technology that enables the customer to do such example and non-limiting things like shop and purchase items in a physical location where the items are placed without needing to checkout with a cashier, scan items or use a special physical cart/basket to track and pay for items. One of the most significant advantages of autonomous stores is the convenience they offer to customers. For instance, customers may simply walk into the store, pick up the items they need, and walk out without having to wait in long checkout lines. This could be a significant time-saver for customers, especially in busy areas or during peak shopping seasons. Additionally, autonomous stores can operate 24/7, allowing customers to shop at any time. Such stores have the potential to reduce labor costs for retailers, since these stores do not require human cashiers. This cost savings can be passed on to customers through lower prices, making it a win-win situation for both retailers and customers.

Unfortunately, there are a number of significant disadvantages with such autonomous stores. For instance, one major challenge is the cost of implementing these stores. The technology, such as cameras, sensors and other related devices required for autonomous stores can be expensive, and retailers may need to invest a significant amount of money to set them up. Additionally, retailers may need to ensure that the technology is reliable and secure to prevent theft, fraud, and to ensure that customers are not being overcharged or inadvertently paying for items they did not purchase. For example, some cashierless checkout technology can easily be fooled. For instance, theft may occur by obstruction of the cameras, taking a large number of items at once, replacing items brought from home (used items) with brand new, unopened items, etc. Such systems can also mistakenly miss when a customer has placed an item in their basket for purchase. All of these can result in lost revenue for retailers. Still another disadvantage is that there are no cashiers or attendants in the store to assist customers if they have any questions or want to interact with a store employee. Therefore, as will be discussed in greater detail below, the present disclosure may provide an autonomous store with improved technology capable of better detecting fraud, theft, and when a customer has actually taken an item they wish to purchase.

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

Software may include artificial intelligence (AI) systems, which may include machine learning or other computational intelligence. For example, AI may include one or more models used for one or more problem domains. When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

In some implementations, the various computing devices may include, integrate with, link to, exchange data with, be governed by, take inputs from, and/or provide outputs to one or more AI systems, which may include models, rule-based systems, expert systems, neural networks, deep learning systems, supervised learning systems, robotic process automation systems, natural language processing systems, intelligent agent systems, self-optimizing and self-organizing systems, and others. Except where context specifically indicates otherwise, references to AI, or to one or more examples of AI, should be understood to encompass one or more of these various alternative methods and systems; for example, without limitation, an AI system described for enabling any of a wide variety of functions, capabilities and solutions described herein (such as optimization, autonomous operation, prediction, control, orchestration, or the like) should be understood to be capable of implementation by operation on a model or rule set; by training on a training data set of human tag, labels, or the like; by training on a training data set of human interactions (e.g., human interactions with software interfaces or hardware systems); by training on a training data set of outcomes; by training on an AI-generated training data set (e.g., where a full training data set is generated by AI from a seed training data set); by supervised learning; by semi-supervised learning; by deep learning; or the like. For any given function or capability that is described herein, neural networks of various types may be used, including any of the types described herein, and in embodiments a hybrid set of neural networks may be selected such that within the set a neural network type that is more favorable for performing each element of a multi-function or multi-capability system or method is implemented. As one example among many, a deep learning, or black box, system may use a gated recurrent neural network for a function like language translation for an intelligent agent, where the underlying mechanisms of AI operation need not be understood as long as outcomes are favorably perceived by users, while a more transparent model or system and a simpler neural network may be used for a system for automated governance, where a greater understanding of how inputs are translated to outputs may be needed to comply with regulations or policies.

Examples of the models (e.g., AI-based models) include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformers (GPT). Training a machine-learning model (or other type of AI-based learning models) may include supervised learning (for example, based on labelled input data), unsupervised learning, and reinforcement learning. In various embodiments, a machine-learning model may be pre-trained by their operator or by a third party. Problem domains include nearly any situation where structured data can be collected, and includes natural language processing (NLP), including natural language understanding (NLU), computer vision (CV), classification, image recognition, etc. Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc. Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

In some implementations, as noted above, AI-based learning models may include at least one of a transformer model, a convolutional neural network, a deep learning model trained on a set of outcomes of the value chain network entity, a supervised model, a semi-supervised model, an unsupervised model, or a reinforcement model, and the training data set for the AI-based learning models may include one or a set of objects or events that are labeled to classify the set of objects or events according to a classification taxonomy. Other examples of AI-based learning models (e.g., machine learning models) may include neural networks in general (e.g., deep neural networks, convolution neural networks, and many others), regression-based models, decision trees, hidden forests, Hidden Markov models, Bayesian models, and the like. In some implementations, the present disclosure may include combinations where an expert system uses one neural network for classifying an item and a different (or the same) neural network for predicting a state of the item.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium or storage device may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, solid state drives (SSDs), a digital versatile disk (DVD), a Blu-ray disc, and an Ultra HD Blu-ray disc, a static random access memory (SRAM), dynamic RAM (DRAM), synchronous DRAM (SDRAM), synchronous graphics RAM (SGRAM), and video RAM (VRAM), analog magnetic tape, digital magnetic tape, rotating hard disk drive (HDDs), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

Examples of storage implemented by the storage hardware include a distributed ledger, such as a permissioned or permissionless blockchain. Entities recording transactions, such as in a blockchain, may reach consensus using an algorithm such as proof-of-stake, proof-of-work, and proof-of-storage. Elements of the present disclosure may be represented by or encoded as non-fungible tokens (NFTs). Ownership rights related to the non-fungible tokens may be recorded in or referenced by a distributed ledger. Transactions initiated by or relevant to the present disclosure may use one or both of fiat currency and cryptocurrencies, examples of which include bitcoin and ether.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electromagnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a network, such as a cellular network, local area network (LAN), a wide area network (WAN), a body area network BAN), a personal area network (PAN), a metropolitan area network (MAN), etc., or the connection may be made to an external computer (for example, through the internet using an Internet Service Provider). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs), etc. In some implementations, electronic circuitry including, for example, programmable logic circuitry, an application specific integrated circuit (ASIC), gate arrays such as field-programmable gate arrays (FPGAs) or other hardware accelerators, micro-controller units (MCUs), or programmable logic arrays (PLAs), integrated circuits (ICs), digital circuit elements, analog circuit elements, combinational logic circuits, digital signal processors (DSPs), complex programmable logic devices (CPLDs), etc. may execute the computer readable program instructions/code by utilizing state information of the computer readable program instructions to personalize the electronic circuitry, in order to perform aspects of the present disclosure. Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an AI system-on-chip, a video processing system-on-chip, an organ-on-chip, a quantum algorithm system-on-chip, etc.

Examples of processing hardware may include, e.g., a central processing unit (CPU), a graphics processing unit (GPU), an approximate computing processor, a quantum computing processor, a parallel computing processor, a neural network processor, a signal processor, a digital processor, an analog processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an AI co-processor.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

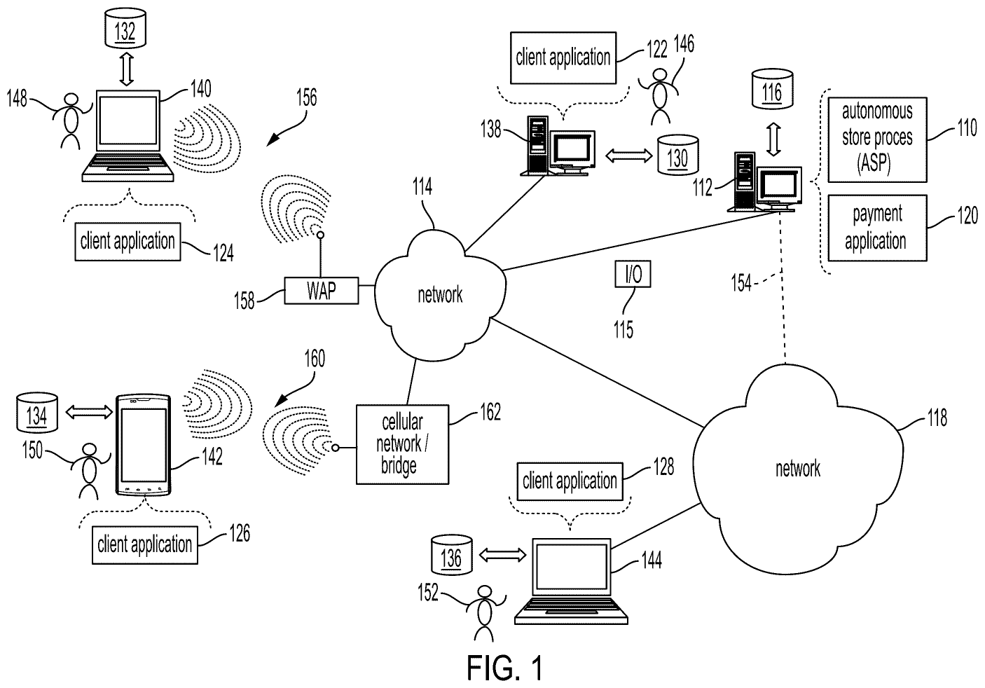

Referring now to the example implementation of FIG. 1, there is shown ASP 110 that may reside on and may be executed by a computer (e.g., computer 112), which may be connected to a network (e.g., network 114) (e.g., the internet or a local area network). Examples of computer 112 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). A SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 112 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, an autonomous store process (ASP), such as ASP 110 of FIG. 1, may secure, using a first portion of a plurality of interior attachment points, equipment to an interior portion of a portable building structure. The equipment may be secured, using a second portion of the plurality of interior attachment points, to the interior portion of the portable building structure for transportation of the portable building structure. The portable building structure may be enabled, using a first portion of a plurality of exterior attachment points, to be lifted off a ground surface prior to transportation. The portable building structure may be enabled, using a second portion of a plurality of exterior attachment points, to be secured to a vehicle for transportation. A computing device tracking system may be installed to track at least one user within the portable building structure and to determine whether the at least one user has taken an object from a first location within the portable building structure and placed it in a second location within the portable building structure.

In some implementations, as will be discussed below in greater detail, an autonomous store process (ASP), such as ASP 110 of FIG. 1, may track, by a computing device, at least one user within an autonomous environment. It may be determined that the at least one user has taken an object from a first location and placed it in a second location. An object ID of the object may be added to a data container based upon, at least in part, determining that the at least one user has taken the object from the first location and placed it in the second location. It may be detected that the at least one user has entered a predefined area while the object ID is in the data container. Checkout may be initiated for the at least one user to provide an amount equal to a total charge for the object based upon, at least in part, detecting that the at least one user has entered the predefined area while the object ID is in the data.

In some implementations, the instruction sets and subroutines of ASP 110, which may be stored on storage device, such as storage device 116, coupled to computer 112, may be executed by one or more processors and one or more memory architectures included within computer 112. In some implementations, storage device 116 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 116 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 114 may be connected to one or more secondary networks (e.g., network 118), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 112 may include a data store, such as a database (e.g., relational database, object-oriented database, triplestore database, etc.), a data store, a data lake, a column store, and/or a data warehouse, and may be located within any suitable memory location, such as storage device 116 coupled to computer 112. In some implementations, data, metadata, information, etc. described throughout the present disclosure may be stored in the data store. In some implementations, computer 112 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, ASP 110 may be a component of the data store, a standalone application that interfaces with the above noted data store and/or an applet/application that is accessed via client applications 122, 124, 126, 128. In some implementations, the above noted data store may be, in whole or in part, distributed in a cloud computing topology. In this way, computer 112 and storage device 116 may refer to multiple devices, which may also be distributed throughout the network.

In some implementations, computer 112 may execute a payment application (e.g., payment application 120), examples of which may include, but are not limited to, e.g., a touch screen application, a biometrics application (e.g., facial recognition, fingerprint, palm print, retinal scan, voice print, etc.), a payment processing application (e.g., Point of Sale applications, such as contactless payment solutions), a smart inventory management application, an automatic speech recognition (ASR) application (e.g., speech recognition application 120), examples of which may include, but are not limited to, e.g., an automatic speech recognition (ASR) application (e.g., modeling, transcription, etc.), a natural language understanding (NLU)/natural language processing (NLP) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a virtual reality (VR) application, an extended reality (XR) application also known as mixed reality (MR), an augmented reality (AR) application, a web conferencing application, a video conferencing application, a telephony application, a voice-over-IP application, a video-over-IP application, an Instant Messaging (IM)/“chat” application, a chatbot application, an interactive voice response (IVR) application, a short messaging service (SMS)/multimedia messaging service (MMS) application, or other application that allows for processing payments and/or remote collaboration. In some implementations, ASP 110 and/or payment application 120 may be accessed via one or more of client applications 122, 124, 126, 128. In some implementations, ASP 110 may be a standalone application, or may be an applet/application/script/extension that may interact with and/or be executed within payment application 120, a component of payment application 120, and/or one or more of client applications 122, 124, 126, 128. In some implementations, payment application 120 may be a standalone application, or may be an applet/application/script/extension that may interact with and/or be executed within ASP 110, a component of ASP 110, and/or one or more of client applications 122, 124, 126, 128. In some implementations, one or more of client applications 122, 124, 126, 128 may be a standalone application, or may be an applet/application/script/extension that may interact with and/or be executed within and/or be a component of ASP 110 and/or payment application 120. Examples of client applications 122, 124, 126, 128 may include, but are not limited to, e.g., a VR application, XR or MR application, an AR application, a touch screen application, a biometrics application (e.g., facial recognition, fingerprint, palm print, retinal scan, voice print, etc.), a payment processing application, an automatic speech recognition (ASR) application (e.g., speech recognition application 120), examples of which may include, but are not limited to, e.g., an automatic speech recognition (ASR) application (e.g., modeling, transcription, etc.), a natural language understanding (NLU)/natural language processing (NLP) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a virtual reality (VR) application, an extended reality (XR) application also known as mixed reality (MR), an augmented reality (AR) application, a web conferencing application, a video conferencing application, a telephony application, a voice-over-IP application, a video-over-IP application, an Instant Messaging (IM)/“chat” application, a chatbot application, an interactive voice response (IVR) application, a short messaging service (SMS)/multimedia messaging service (MMS) application, or other application that allows for processing payments and/or remote collaboration, a standard and/or mobile web browser, an email application (e.g., an email client application), a textual and/or a graphical user interface, a customized web browser, a plugin, an Application Programming Interface (API), or a custom application. The instruction sets and subroutines of client applications 122, 124, 126, 128, which may be stored on storage devices 130, 132, 134, 136, coupled to client electronic devices 138, 140, 142, 144, may be executed by one or more processors and one or more memory architectures incorporated into client electronic devices 138, 140, 142, 144.

In some implementations, one or more of storage devices 130, 132, 134, 136, may include but are not limited to: hard disk drives; flash drives, tape drives; optical drives; RAID arrays; random access memories (RAM); and read-only memories (ROM). Examples of client electronic devices 138, 140, 142, 144 (and/or computer 112) may include, but are not limited to, a personal computer (e.g., client electronic device 138), a laptop computer (e.g., client electronic device 140), a smart/data-enabled, cellular phone (e.g., client electronic device 142), a notebook computer (e.g., client electronic device 144), a tablet, a server, a television, a smart television, a smart speaker, an Internet of Things (IoT) device, a media (e.g., audio/video, photo, etc.) capturing and/or output device, an audio input and/or recording device (e.g., a handheld microphone, a lapel microphone, an embedded microphone/speaker (such as those embedded within eyeglasses, smart phones, tablet computers, smart televisions, smart speakers, watches, etc.), an infotainment device (e.g., such as those found in vehicles combining information and/or entertainment with optional screens and/or audio for such things as navigation, multimedia, connectivity, voice control, smartphone integration, touchscreen interface, internet and apps, rear-seat entertainment, etc.), a dedicated network device, and combinations thereof. Client electronic devices 138, 140, 142, 144 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 122, 124, 126, 128 may be configured to effectuate some or all of the functionality of ASP 110 (and vice versa). Accordingly, in some implementations, ASP 110 may be a purely server-side application, a purely client-side application, or a hybrid server-side/client-side application that is cooperatively executed by one or more of client applications 122, 124, 126, 128 and/or ASP 110.

In some implementations, one or more of client applications 122, 124, 126, 128 may be configured to effectuate some or all of the functionality of payment application 120 (and vice versa). Accordingly, in some implementations, payment application 120 may be a purely server-side application, a purely client-side application, or a hybrid server-side/client-side application that is cooperatively executed by one or more of client applications 122, 124, 126, 128 and/or payment application 120. As one or more of client applications 122, 124, 126, 128, ASP 110, and payment application 120, taken singly or in any combination, may effectuate some or all of the same functionality, any description of effectuating such functionality via one or more of client applications 122, 124, 126, 128, ASP 110, payment application 120, or combination thereof, and any described interaction(s) between one or more of client applications 122, 124, 126, 128, ASP 110, payment application 120, or combination thereof to effectuate such functionality, should be taken as an example only and not to limit the scope of the disclosure.

In some implementations, one or more of users 146, 148, 150, 152 may access computer 112 and ASP 110 (e.g., using one or more of client electronic devices 138, 140, 142, 144) directly through network 114 or through network 118. Further, computer 112 may be connected to network 114 through network 118, as illustrated with phantom link line 154. ASP 110 may include one or more user interfaces, such as browsers and textual or graphical user interfaces, through which users 146, 148, 150, 152 may access ASP 110.

In some implementations, the various client electronic devices may be directly or indirectly coupled to network 114 (or network 118). For example, client electronic device 138 is shown directly coupled to network 114 via a hardwired network connection. Further, client electronic device 144 is shown directly coupled to network 118 via a hardwired network connection. Client electronic device 140 is shown wirelessly coupled to network 114 via wireless communication channel 156 established between client electronic device 140 and wireless access point (i.e., WAP 158), which is shown directly coupled to network 114. WAP 158 may be, for example, an IEEE 802.11a, 802.11b, 802.11g, 802.11n, 802.11ac, Wi-Fi®, RFID, and/or Bluetooth™ (including Bluetooth™ Low Energy) or any device that is capable of establishing wireless communication channel 156 between client electronic device 140 and WAP 158 (e.g., Zigbee, Z-Wave, etc.). Client electronic device 142 is shown wirelessly coupled to network 114 via wireless communication channel 160 established between client electronic device 142 and cellular network/bridge 162, which is shown by example directly coupled to network 114.

In some implementations, some or all of the IEEE 802.11×specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used. In some implementations, computer 112 may be directed or controlled by an operator (e.g., store owner, security personnel, management company, etc.). Computer 112 may be hosted by one or more of assets owned by the operator, assets leased by the operator, and third-party assets. The assets may be referred to as a private, community, or hybrid cloud computing network or cloud computing environment. For example, computer 112 may be partially or fully hosted by a third party offering software as a service (SaaS), platform as a service (PaaS), and/or infrastructure as a service (IaaS).

In some implementations, various I/O requests (e.g., I/O request 115) may be sent from, e.g., client applications 122, 124, 126, 128 to, e.g., computer 112 (and vice versa). Examples of I/O request 115 may include but are not limited to, data write requests (e.g., a request that content be written to computer 112) and data read requests (e.g., a request that content be read from computer 112). Client electronic devices 138, 140, 142, 144 and/or computer 112 may also communicate audibly using an audio codec, which may receive spoken information from a user and convert it to usable digital information. An audio codec may likewise generate audible sound for a user, such as through a speaker, e.g., in a handset of a client electronic device. Such sound may include sound from voice telephone calls, may include recorded sound (e.g., voice messages, music files, etc.) and may also include sound generated by applications operating on the client electronic devices.

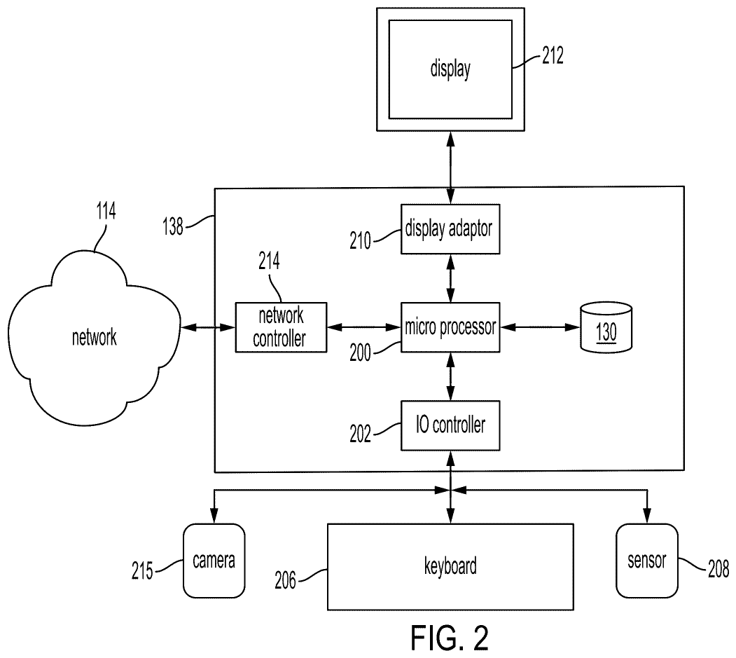

Referring also to the example implementation of FIG. 2, there is shown a diagrammatic view of client electronic device 138. While client electronic device 138 is shown in this figure, this is for example purposes only and is not intended to be a limitation of this disclosure, as other configurations are possible. Additionally, any computing device capable of executing, in whole or in part, ASP 110 may be substituted for client electronic device 138 (in whole or in part) within FIG. 2, examples of which may include but are not limited to computer 112 and/or one or more of client electronic devices 140, 142, 144.

In some implementations, client electronic device 138 may include a processor (e.g., microprocessor 200) configured to, e.g., process data and execute the above-noted code/instruction sets and subroutines. Microprocessor 200 may be coupled via a storage adaptor to the above-noted storage device(s) (e.g., storage device 130). An I/O controller (e.g., I/O controller 202) may be configured to couple microprocessor 200 with various devices (e.g., via wired or wireless connection), such as keyboard 206, pointing/selecting device (e.g., touchpad, touchscreen, mouse, etc.), a sensor (e.g., sensor 208) scanner, audio/visual device (e.g., camera 215), USB ports, and printer ports. A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to network 114 (e.g., the Internet or a local area network).

As will be discussed in greater detail below, to provide an improved shopping experience for both shopkeepers/operators and consumers, the present disclosure describes a portable store to provide a flexible and adaptive solution to address the example and non-limiting challenges described above. The portable store may be designed to be modular and easily disassembled, easily reassembled, enabling efficient transportation (with or without requiring equipment to be moved in the transportation process) at different locations. This mobility, along with the ability to maintain some or all equipment in their desired locations during transportation, allows operators to strategically position a near “turn key” store in areas of high demand, respond to special events, or capitalize on emerging market opportunities.

Components of the portable convenience store system may include, by way of example and not limitation, a modular building structure, integrated shelving and display units, utility connections for power and water, and a secure foundation for stability. The design may leverage lightweight materials and innovative construction methods to ensure portability without compromising structural integrity or the ability to stock a diverse range of products. Additionally, the portable store system may incorporate advanced technology, such as smart inventory management systems, contactless payment solutions, and energy-efficient systems. These features enhance operational efficiency, reduce environmental impact, and align with modern consumer expectations for convenience and sustainability.

As will be discussed in greater detail below, example aspects of the store may include a novel exterior having a size, shape, and configuration to enable the store to be transported with relative ease. A unique door entry system may also be included, leading to the interior of the store's unique interior design, equipment layout, camera system, smart shelving system, network, network cabling system, and an equipment attachment system. In some implementations, the portable store may include a unique electric design, equipment having remote monitoring capabilities, and various other equipment for providing products and/or services expected and appreciated by consumers visiting the store.

### Portable Store:

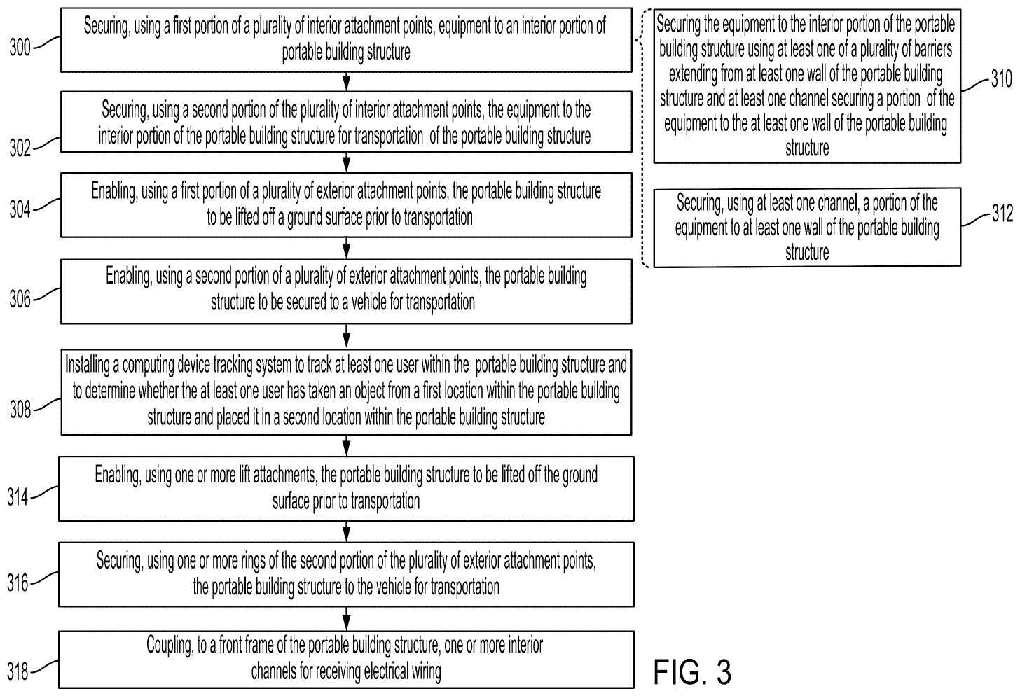

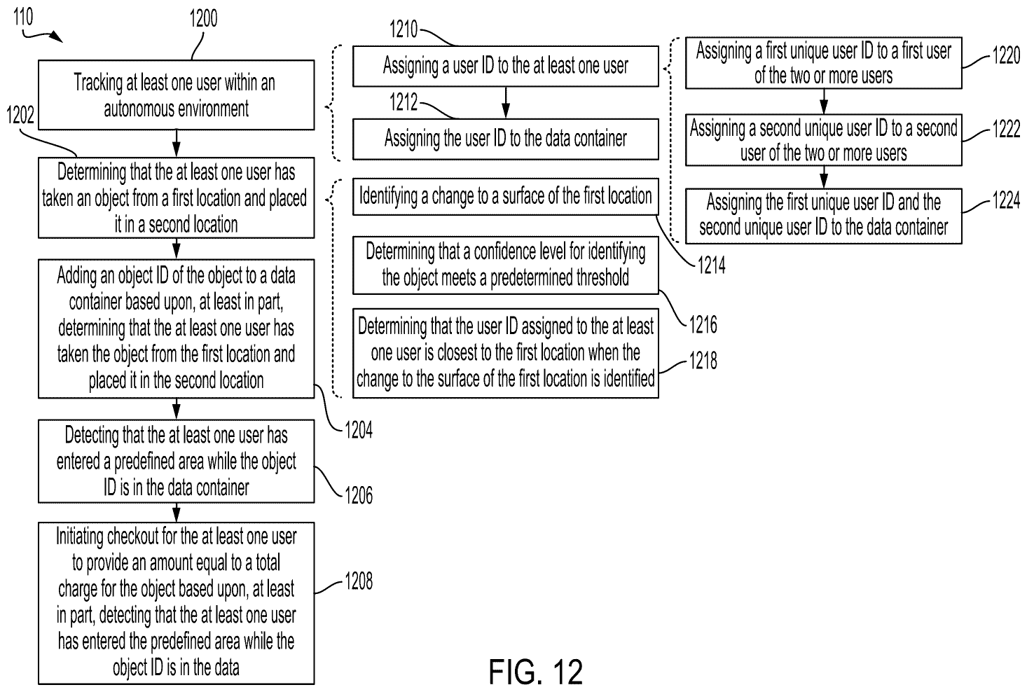

As discussed above and referring also at least to the example implementations of FIGS. 3-14, ASP 110 may secure 300, using a first portion of a plurality of interior attachment points, equipment to an interior portion of a portable building structure. ASP 110 may secure 302 the equipment to the interior portion of the portable building structure for transportation of the portable building structure using a second portion of the plurality of interior attachment points. ASP 110 may enable 304 the portable building structure to be lifted off a ground surface prior to transportation using a first portion of a plurality of exterior attachment points. ASP 110 may enable 306 the portable building structure to be secured to a vehicle for transportation using a second portion of a plurality of exterior attachment points. ASP 110 may install 308 a computing device tracking system to track at least one user within the portable building structure and to determine whether the at least one user has taken an object from a first location within the portable building structure and placed it in a second location within the portable building structure.

It will be appreciated after reading the present disclosure that some (but not all) portions of ASP 110 may be physical acts performed by a person and/or a manufacturing facility. For example, the flowchart shown in FIG. 3 may be performed by a person and/or machinery in a manufacturing facility. In some implementations, the machinery in the manufacturing facility may be performing the physical acts by executing instructions provided by ASP 110. As such, the description of ASP 110 being all physical or all computer instructions should be taken as example only and not to otherwise limit the scope of the present disclosure.

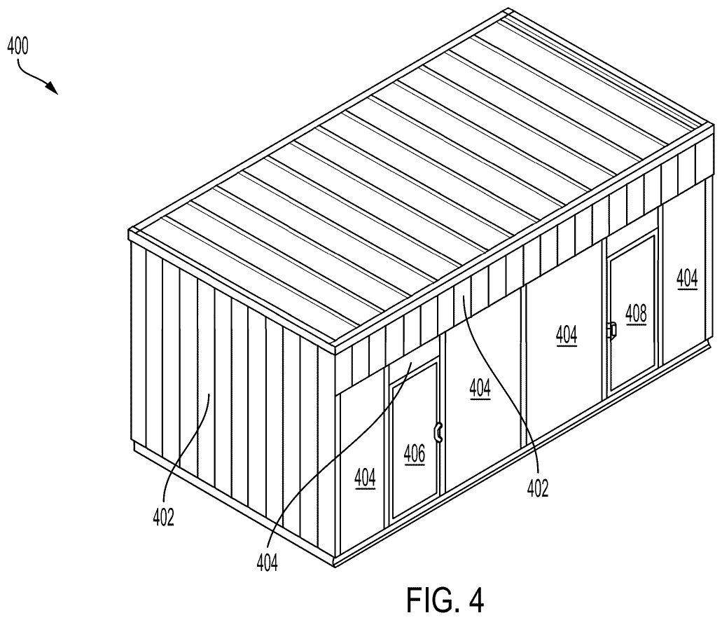

In some implementations, and referring at least to the example implementation of FIG. 4, an example portable store (e.g., portable store 400) is shown. As shown in FIG. 4, portable store 400 is shown with metal panels (e.g., panels 402) on front, side and rear exterior walls, although it will be appreciated that other materials (e.g., wood panels, composite panels, fiber cement panels, vinyl siding, glass panels, polycarbonate panels, PVC panels, insulated sandwich panels, etc.) may be used in any combination without departing from the present disclosure. In the example, panels 402 on exterior side walls are laid vertically with each panel being the same height as the store. In some implementations, portable store 400 may be fully front faced with glass (e.g., glass 404) and may include an area of metal paneling above the front glass door up to the roof. In some implementations, separate entry and exit doors may be provided, as shown in FIG. 4 (e.g., entry door 406 and exit door 408). The roof (e.g., roof 410) may have a gentle slope to the rear, allowing water to drain off the back of the store without needing to attach guttering (maintaining the streamlined store appearance and avoiding adding things that could reduce store portability). The roof design may also be designed so that it may hold roof-mounted solar panels should that be desired. In some implementations, the either side of the store front (e.g., running from the base to the roof height) of portable store 400 may have a vertical S-channel on the corner of each front face. The S-channel design may allow strip LED lighting (or other type of electrical wiring) to be positioned vertically behind the channels on each corner.

Advantageously, the example configuration of FIG. 4 may provide portable store 400 with a unique appearance, while still being practical and hardwearing. The glass front may allow consumers to see fully inside the store, making it more inviting and giving a perception of greater safety. In some implementations, the glass may be strengthened glass for further security or stability (e.g., bulletproof; hurricane-proof; shatterproof, etc.). The area of metal paneling above the glass area of portable store 400 gives space for a retailer to attach a branded sign. Generally, the separate entry and exit doors may allow for a simple one-way consumer flow, preventing consumers needing to return to the same door and potentially obstructing other consumers entering the store. In some implementations, the front of portable store 400 may be entirely or more open than not, or other parts of portable store 400 may be completely or substantially open. As such, the description of portable store 400 having a front wall, back wall, left side wall and right side wall should be taken as example only and not to otherwise limit the scope of the present disclosure.

In some implementations, the size and shape of portable store 400 may be planned such that it is both consumer friendly and portable. For instance, by way of example and not limitation, a store with an exterior dimension of 22 ft×12 ft×11 ft may be designed to maximize the internal space, while enabling the store to be portable and easy to lift. This dimension also allows a ceiling height that may enable an autonomous solution (discussed further below) to work more effectively, as well as contributing to a more spacious feel inside the store. With such dimensions, the store shape may feel more like a traditional convenience store, rather than a converted shipping container. Restricting the width to 12 ft enables the store to be transported on a single truck without needing permits for an accompanied wide load. Notably, as permitting dimensions change, so shall the example width restriction. Should the ability to transport on a single vehicle without permitting not be a concern, example and non-limiting dimensional ranges of portable store 400 may include 20′×8′ to 40′×20′.

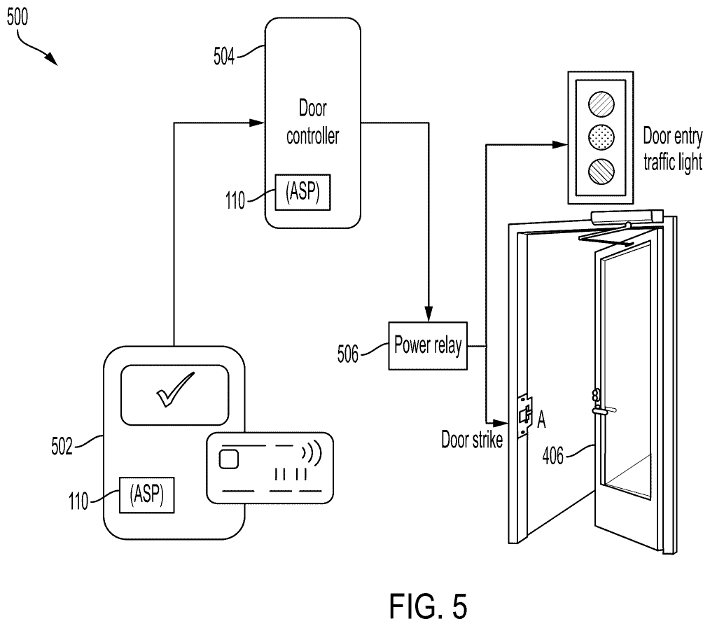

In some implementations, and referring to the example implementation of FIG. 5, an example door entry system (e.g., door entry system 500) is shown. In the example, door entry system 500 may be configured to include swing doors (or other types of door) at the entrance and exit, as well as panic bar devices. Swing doors may be selected rather than sliding doors to maximize space within portable store 400, as sliding door may require significant clearance space, which may restrict positioning of gondolas near the door and may reduce the amount of gondola space available for displaying product).

In some implementations, door entry system 500 may include a payment device (e.g., payment device 502) mounted near entry door 406, electronic strike mechanism (A) on entry door 406, a door controller (e.g., door controller 504) and power relay (e.g., power relay 506) that connects between the payment device and the strike mechanism. The door controller and power relay may automatically trigger the door to unlock when a payment card is presented and authorized using payment device 502, allowing consumer entry. It will be appreciated after reading the present disclosure that other types of entry mechanisms may also be used, such as RFID, Bluetooth, FOB, client electronic devices, or other wireless means, etc.

In some implementations, an indicator (e.g., indicator 508) may be used inform a consumer whether they are able to enter portable store 400. For instance, indicator 508 may be a “traffic light” at the entry door, linked to payment device 502 and the door strike, so that when the door is automatically unlocked (e.g., following payment authorization or other technique) the light turns green, indicating that the consumer may enter. Similarly, indicator 508 may have a red light, indicating that entry is not currently permitted for a variety of reasons (e.g., too many people inside, or the store is closed). In some implementations, indicator 508 may be a digital screen at the entrance linked to the payment device to inform consumers when they can enter the store, and may also be used to play audio/video to support communicating to consumers how to use the store. In some implementations, door controller 504 may have the ability to remotely lock and unlock the doors via functionality presented through a client electronic device application and/or website.

In some implementations, the example door entry control system may ensure no entry is granted to consumers without them having first identified or authorized their payment card. The traffic light system/digital screen makes it easier for consumers to understand when they can enter the store, rather than just relying on hearing the click of the door lock when it unlocks. The remote control of the doors allows employees and other people to gain entry to the store without needing to present a payment card. In some implementations, users may use an associated client electronic device application (e.g., a storeowner's loyalty app) to enter by, e.g., presenting a code or similar on the user's client electronic device to a reader at the door, or using biometrics (face scan, fingerprint scan, palm scan, etc.).

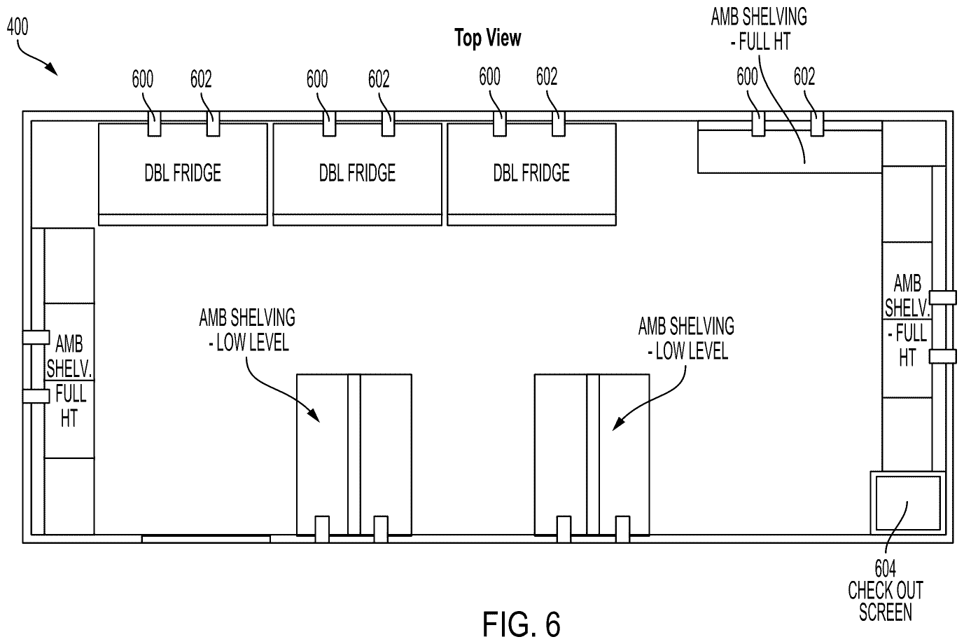

Referring at least to the example implementation of FIG. 6, a top view of the inside of portable store 400 is shown. It will be appreciated after reading the present disclosure that the specific layout, dimensions, and equipment used throughout are for ease of explanation, and not to limit the scope of the present disclosure. As such, other layouts, dimensions, and equipment may be used without departing from the scope of the present disclosure. In some implementations, the layout of the equipment inside the store is shown with three double fridges on the rear walls, two high level wall gondolas on each side and one on the rear wall. There is further included for example purposes only two low level island gondolas coming out from the front wall into the middle of the store, a checkout screen by the exit door, a server cabinet and adjoining server shelf mounted above the fridges. An example and non-limiting advantage of the layout is that the low height of the gondolas at the front ensures that consumers both outside and inside the store have full visibility across the whole store at all times. This makes the store feel more open, and also makes it feel more secure. The island gondolas contribute to a layout that feels more like a traditional convenience store rather than a converted shipping container. The equipment space is maximized such that a larger size range can be offered within the space, without making the store feel too crowded. The single gondola unit on rear wall allows for flexibility, as this can be swapped out for other equipment such as a coffee machine, microwave oven, etc., without needing to change the camera layout on the ceiling or elsewhere. Sufficient space is left clear on the back wall to enable a fire extinguisher and cabinet to be placed there to meet local fire regulations.

In some implementations, and referring again to FIG. 6, ASP 110 may secure 300, using a first portion of a plurality of interior attachment points, equipment to an interior portion of a portable building structure. For example, equipment (e.g., refrigerators, microwaves, shelving, etc.) may be secured to portable store 400 using interior attachment points. For instance, in some implementations, securing the equipment to the interior portion of the portable building structure may include securing 310 the equipment to the interior portion of the portable building structure using at least one of a plurality of barriers extending from at least one wall of the portable building structure (or at least one channel securing a portion of the equipment to the at least one wall of the portable building structure, as discussed below). As an example, the equipment attachment techniques may keep the interior of the store as it would be during customer use, even when the store is being transported. For instance, to prevent movement of the refrigerators (also referred to herein as fridges), a plurality of barriers (e.g., barriers 600) may be used. In some implementations, barriers 600 may be two metal “fins” that extend from, e.g., the rear wall and positioned on either side of the row of fridges to prevent sideways movement. It may be important to keep the equipment in the exact (or near exact) location for the autonomous system (discussed in greater detail below) to work properly. Barriers 600 may prevent sideways movement of the fridges away from their standard position, while still enabling the fridges to be pulled forwards out of their position when required (e.g., for repairs, to access rear cabling, etc.). This same system prevents sideways movement during transportation when fridges are strapped to the walls.

In some implementations, other forms of barriers 600 (e.g., a wooden block, a metal channel, etc.) may be attached to the floor at either end of the fridge run or either end of each individual fridge, running down the outer side of the fridge castors. In some implementations, barriers 600 may include a bracket attached to the fridge that then screws/bolts into the wall (if reinforced) or into a length of a strut channel system or e-track or similar attached to the wall behind (although with this method, the bracket may then have to be unscrewed/unbolted any time one needed to pull the fridges forwards, so it is less optimal).

Generally, a strut channel system may include long, steel channels with inwards-facing lips for the attachment of various connectors, brackets, and other hardware. The system is typically modular, versatile, and does not require welding, making it easily adjustable and reusable. The strut channel system may be used in many applications, including construction, electrical systems, plumbing, and for creating various industrial supports and structures. E-track generally refers to a system primarily used for securing cargo in the transportation industry. It typically includes metal tracks that can be mounted inside trailers, cargo vans, and moving trucks. The tracks may have a series of slots into which e-track fittings, straps, and other securing accessories can be inserted to hold cargo in place during transport.

In some implementations, ASP 110 may secure 302 the equipment to the interior portion of the portable building structure for transportation of the portable building structure using a second portion of the plurality of interior attachment points, where, in some implementations, securing the equipment to the interior portion of the portable building structure for transportation of the portable building structure may include securing 312 a portion of the equipment to at least one wall of the portable building structure using at least one channel (and/or the plurality of barriers discussed above). For instance, and referring still at least to FIG. 6, a second portion of the plurality of interior attachment points may include a channel (e.g., channel 602). In the example, to secure fridges to the rear wall during times when the store is being moved, channel 602 (e.g., e-track fittings) may be attached to the walls at points on either side of the fridge (e.g., with attachment points being aligned with the wall struts where possible for reinforcement).

In some implementations, the fridges may be secured using a horizontal run of strut channels or e-track fittings attached to the wall behind the fridges that ratchet straps can then be hooked into to strap the fridges to the walls for transportation. The track may be bolted/screwed into the wall struts where possible to ensure appropriate strength/reinforcement. This technique may obviate the need to use reinforcement into the walls behind the fridges, which is more expensive. This technique may also provide flexibility on where the ratchet straps can be hooked into. As another example, there may be small vertical runs of strut channel/e-track channels attached to the walls at either end of the run of fridges, and the fridges may be ratchet strapped to them. In some implementations, D-rings (or similar attachments) may be attached at points of the walls at either end of the run of fridges and ratchet strapped to them. Generally, these may not be optimal, as it may need the track/channel/D-rings to be positioned where the wall struts are, which may be behind the fridges or behind other equipment, or reinforcements to the wall may be needed at those points, which is more expensive.

To attach such things as wall gondolas to the walls, a length of e-track (or strut channel or similar channel) may be mounted to the walls behind the gondola units, running the length of the gondola run, to which the gondolas may be bolted via brackets attached to the rear of the gondola. The island gondolas and checkout screen may be bolted to the floor, or otherwise secured to portable store 400. It may be important to keep the equipment in the exact (or near exact) location for the autonomous system (discussed in greater detail below) to work properly and also to prevent equipment movement during transportation, and this system does both things. In some implementations, the design may advantageously leave a sufficient gap between the gondola back and wall to accommodate the data cables that may be required for the autonomous system (described further below). It can also be quickly and easily unbolted from the strut channel system/e-track (and subsequently re-attached) should there be a need to get in behind the gondola shelving. In some implementations, a horizontal run of the strut channel/e-track may be positioned behind the top of the gondola run and may be bolted to the wall (with attachment points being aligned with the wall struts where possible for reinforcement); the gondolas may then be bolted into the strut channel/e-track.

In some implementations, fixing brackets may be used to attach the gondola directly to the wall, although this may not leave space behind the gondola for cables, and may be more difficult to unbolt and re-secure if the gondolas need to be moved away from the walls for any reason. For island gondolas, they may be bolted to the floor using brackets. In some implementations, the checkout screen (e.g., checkout screen 604) may be bolted to the floor (or wall) through the pre-drilled holes in the checkout base.

The example advantages of the attachment system described throughout may include that they keep the equipment in place and prevent movement that might require re-calibration of the camera views for the autonomous system. It may also enable equipment to be safely secured for when the store needs to be lifted by crane and transported to another location, thus supporting the portability of the store.

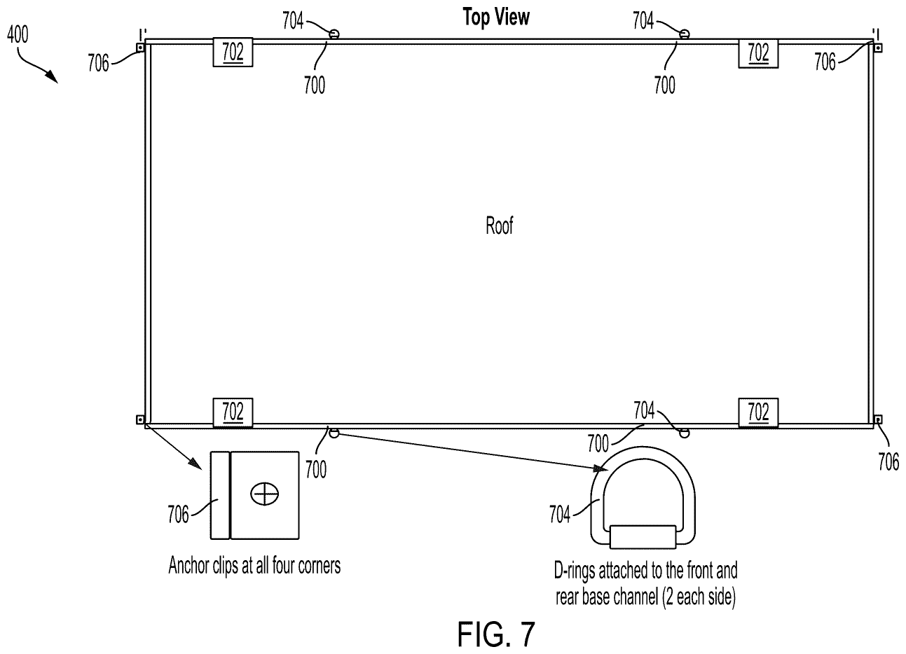

In some implementations, ASP 110 may enable 304 the portable building structure to be lifted off a ground surface prior to transportation using a first portion of a plurality of exterior attachment points. For instance, in some implementations, ASP 110 may enable 314 the portable building structure to be lifted off the ground surface prior to transportation using one or more lift attachments. As an example, and referring at least to the example implementation of FIG. 7, an example top view of the roof of portable store 400 is shown. In the example, in order to make portable store 400 portable, additional external configurations may be provided. This may include four detachable lift attachments (e.g., lift lugs) with attachment points (attachment points 700) on both the front and rear base channel of the store. The lift attachments (e.g., lift lugs, such as lift lugs 702) may be attached to the store to allow it to be lifted, e.g., by crane using ropes, cables, etc.). They may be detachable so they can be removed when transporting portable store 400 to keep its width under the 12 ft requirement for being an unaccompanied wide load (without a permit). Thus, lift lugs 702 can be removed for transportation (as above) rather than needing to be used to secure the store to a transporting vehicle. Advantageously, lift lugs 702 are detachable, so can be removed both for transportation and once the store is in position (as can be a trip hazard). They allow the store to be lifted from points on the base of the store, which are less visible and hence have less of an effect on the visual appearance of the store. In some implementations, the lifting points may be built into the structural design of the roof, so portable store 400 can be lifted from the top, rather than the bottom. In some implementations, portable store 400 may be raised by having forklift pockets running through the base channel of the store, allowing the store to be lifted by a forklift (although this may be less optimal due to the length of the store, as this may require a specialist forklift that is not readily available. In some implementations, portable store 400 may be raised by having hydraulic “legs” either built into the store structure or that can be mounted on the store structure. These may extend and lift the store off the truck flatbed allowing the truck to drive away, and which can then be lowered to the ground without need for either crane or forklift.

In some implementations, ASP 110 may enable 306 the portable building structure to be secured to a vehicle for transportation using a second portion of a plurality of exterior attachment points. For instance, in some implementations, ASP 110 may secure 316 the portable building structure to the vehicle for transportation using one or more rings of the second portion of the plurality of exterior attachment points. In some implementations, the one or more rings (e.g., rings 704) may enable the portable building structure to be secured to the vehicle for transportation without extending beyond a perimeter of the portable building structure. For instance, and referring still to FIG. 7, in order to make portable store 400 portable, additional external configurations may be provided. This may include a plurality of rings 704 (e.g., four D-rings) welded into the base channel of the store (e.g., two on the front and two on the rear side of the store), and four anchor clips (e.g., anchor clips 706), which may be located one at each corner of portable store 400. Anchor clips 706 may be placed at the four corners of the store, where bolts may be driven through them into the ground/foundation, although anchor clips may not be needed depending on location and temporal nature of the store's location. In some implementations, the D-rings may be welded into the base channel and used for attaching the store to the truck during transportation (e.g., positioned at various points in the base channel and used to attach straps that can then be strapped to the truck chassis/flatbed trailer, etc.). This may keep the store securely in position on the truck, preventing movement. Having these means the lift lugs may be removed for transportation (as above), rather than needing to be used to secure the store to the truck. In some implementations, the anchor clips may be used to bolt down the store to a foundation once portable store 400 is in its final destination, providing additional stability. This system supports the portability of portable store 400, as the bolts can easily be removed from the clips whenever the store needs to be moved. Advantageously, use of this system is unobtrusive in terms of visual impact on the store appearance, and it may allow the lift lugs to be removed during transportation, thus ensuring the store width does not exceed 12 ft. Moreover, this system may be a safe mechanism that does not apply stress to the building structure during transportation (e.g., as the base channel is reinforced so the strongest part of the store structure is used as the attachment point).

In some implementations, the lift lugs may be used to attach the store to the truck, but this may expand the store width beyond 12 ft and so would lead to the need to be an accompanied wide load for transportation which is more expensive and complex. In some implementations, the four anchoring points at the store corners may be potentially used to attach straps, which could then be used to secure the store to the truck. In some implementations, long straps may be run over the sides & roof of portable store 400 and clipped into each side of the truck flatbed.

In some implementations, as will be discussed in greater detail below, ASP 110 may install 308 a computing device tracking system to track at least one user within the portable building structure. The tracking system may be used to determine whether the at least one user has taken an object from a first location within the portable building structure and placed it in a second location within the portable building structure.

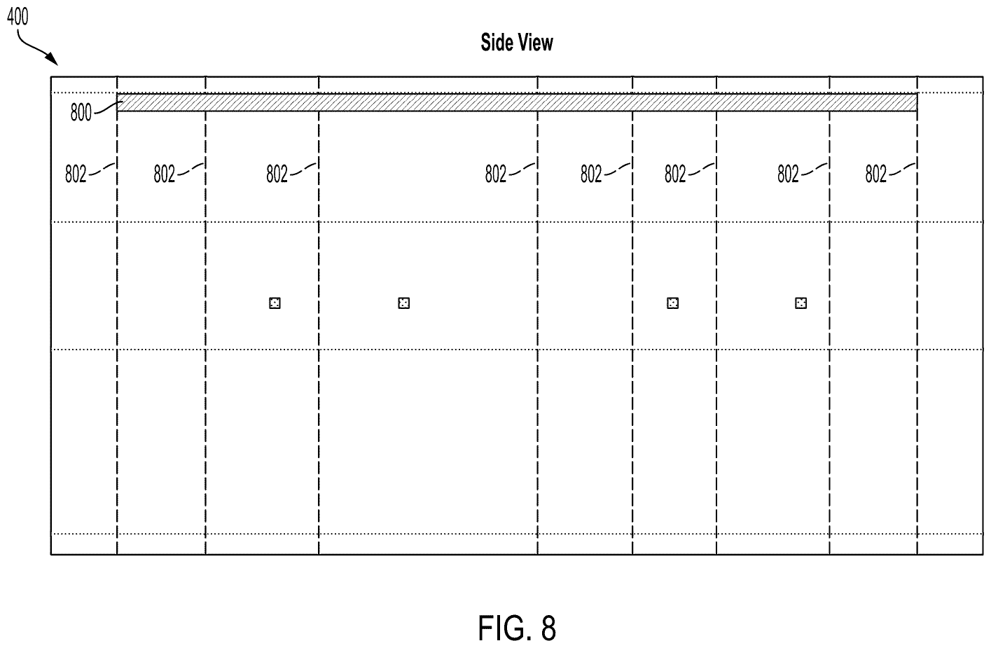

In some implementations, ASP 110 may couple 318 a front frame of the portable building structure to one or more interior channels for receiving electrical wiring. For instance, in some implementations, interior channels for hiding electrical and data cabling may be tied to the storefront frame. For example, and referring to the example implementation of FIG. 8, a side view of portable store 400 is shown. In the example, an interior channel (e.g., channel 800) may include, e.g., a hollow metal channel structure that is rectangular in shape and is designed in shape and size to match exactly (or similarly) to the frame of portable store 400, with, e.g., two or more vertical channels (e.g., channels 802) aligned with two or more vertical frame parts, and one long horizontal channel that aligns with the top part of the storefront frame. In some implementations, a small piece of metal channel may also run from the ceiling down to channel 800. These channels enable the hiding of a significant amount of electrical and data cabling that may be required to run the autonomous system (discussed below). The design ensures that the wireway channel is unobtrusive and looks like an integral part of the store frame, rather than an added channel, thus keeping a clean, streamlined look for the store. In some implementations, the channels may be off-the-shelf conduit, raceway or cable baskets attached to the walls.

In some implementations, the ceiling of portable store 400 may be about 9.5 ft high (although other heights may be used), white walls, black ceiling, black equipment, plywood floor base, and oak effect vinyl flooring. An advantages of such a configuration is that the high ceiling may allow autonomous system (discussed further below) to operate at its most effective, but also contributes to making the store interior feel more open/less cramped. The white walls may contribute to feelings of openness and keep the interior bright. The black ceiling helps to hide much of the cabling and enables black cameras to blend in. Black equipment (e.g., gondolas/fridges) help to hide cabling. The plywood floor base thickness is designed to be robust enough to withstand all equipment and people movement without flexing, which can affect the accuracy of the autonomous system. Oak color for flooring adds warmth and feels less industrial.

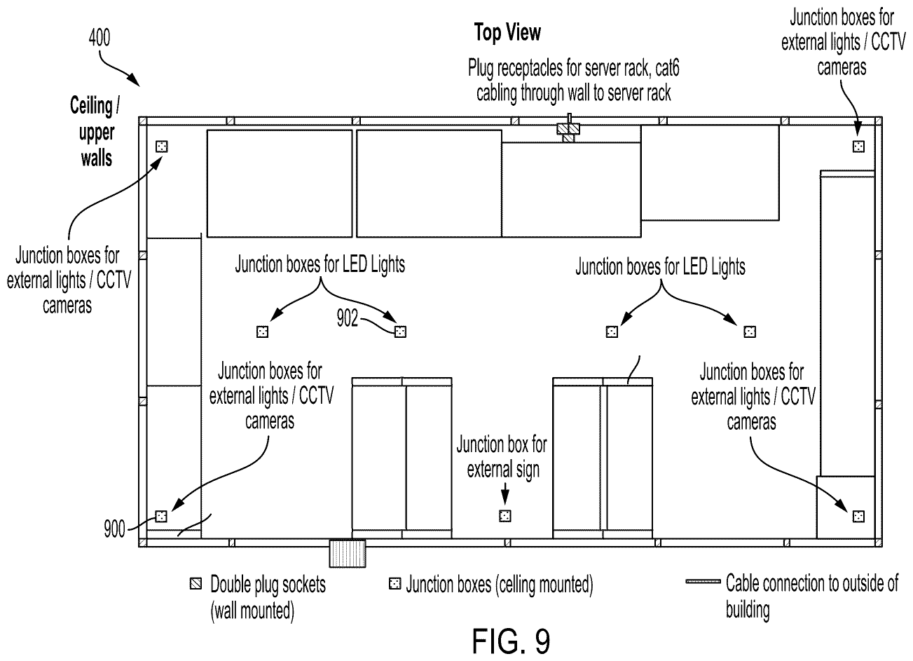

In some implementations, and referring at least to the example implementation of FIG. 9, an internal top view of portable store 400 is shown. In the example, a camera system is shown that may include a grid pattern of strut channels attached directly to the ceiling and painted black to match the ceiling color. In some implementations, a mix of wide angle and standard cameras (e.g., cameras 900), powered over ethernet (for example), may be attached to the strut channels using mounting brackets in set locations. Additional cameras may be attached to each gondola and fridge/freezer shelf. Camera data cables may be wired back to Power of Ethernet (POE) switches in the main server rack, and wires may be parallel run and cable tied along the strut channels. Advantageously, the camera system has a mix of cameras that enable different types of tracking, including wide-angle cameras for tracking people across the store, standard cameras for tracking movements at the shelf edge, and shelf-mounted cameras that face down onto the products displayed on that shelf. The cameras may be positioned to enable full tracking of customer actions across the store and send this data back to the server (e.g., computer 112), which may enable the autonomous technology to work effectively, as will be discussed further below. For example, wide-angle cameras may be positioned so they can track individuals and groups throughout their shopping journey from entering to leaving the store, ensuring their position is known at all times. Standard cameras may be positioned to point directly at all the pieces of equipment so they can track shopper actions at the shelf edge such as reaching in and picking up or putting down a product. Shelf-mounted cameras may be used to support computer vision product recognition to identify the exact products being picked up or placed onto the shelf. The ceiling mounting system may ensure the multiple cameras can be quickly and easily mounted but can also be easily unscrewed and moved if required. It also provides flexibility to easily mount additional equipment if required (e.g., internal CCTV cameras).

In some implementations, portable store 400 may include a smart shelving system, that may include a standard grocery metal gondola shelving base system preferably having weight sensors integrated with and/or attached to the fridge shelves and the ambient gondola shelves. Where not integrated, the weight sensors (e.g., load cells) may be attached to metal brackets that are attached to the shelves. In some implementations, metal surfaces may be positioned on top of the weight sensors. In some implementations, the weight sensors may be integrated with display peg hooks for hanging products. The shelves may be compatible with the attachment of electronic shelf edge labels (ESLs) as well as for attachment of shelf-mounted cameras for product recognition. Data cables may connect the weight sensors to a set of sensor controllers held in the server rack, which in turn connect to the main server. In operation, the autonomous system may provide data about the weight of the products displayed on the shelves/hooks and when there are weight changes due to customers picking up or putting down products.

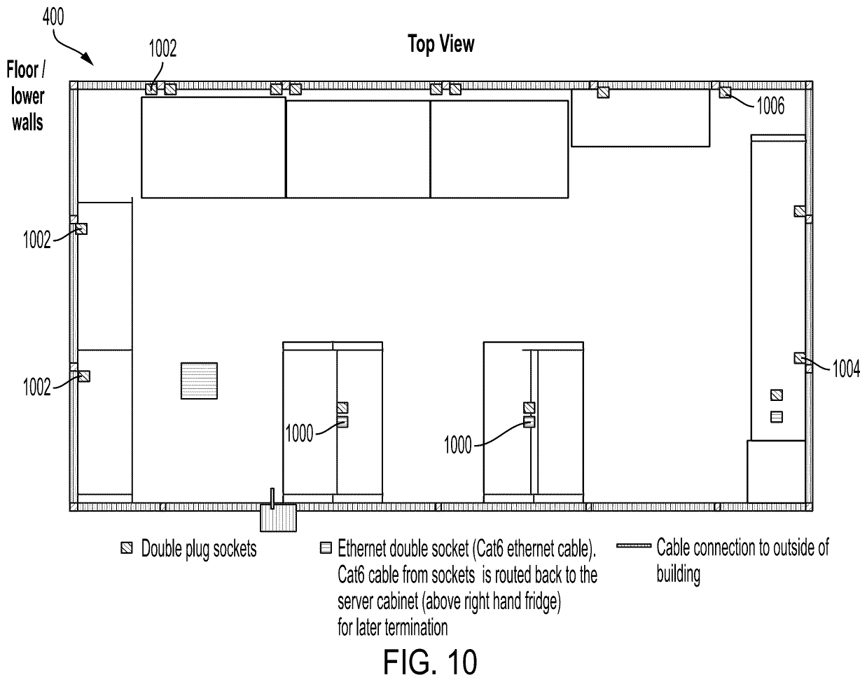

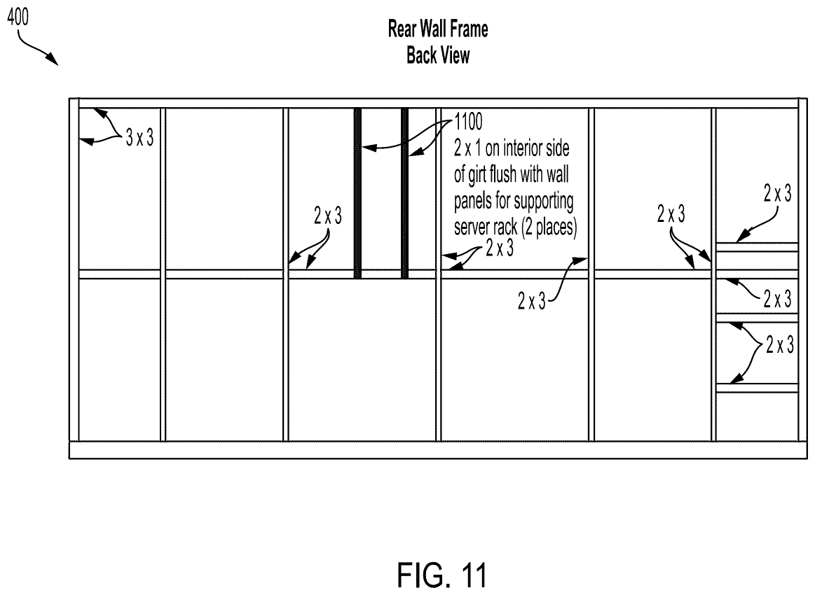

Referring at least to the example implementation of FIG. 10, an internal top view of portable store 400 is shown. In the example, the store network and network cabling system (discussed above) enable network connectivity to the store to be via fixed line, mobile 4G/5G or satellite internet service (or otherwise). The exit point for the cable may be on the rear wall of the store for connection of the internet service provider (ISP) into the router. A Cloud switch may also be included. Ethernet cables may run under the floor to ethernet sockets positioned under the two island gondolas and to a point near to the checkout screen. The cable basket running the length of the store at the rear to hide all cabling from the gondolas and the camera cabling (as discussed above). A cable trunking system may be located along the front wall of the store, and shaped to align with the frame of the storefront system and designed to blend into the store background so as to appear as an integral part of the store structure and not be noticeable. Cable conduits may be included for running down each of the back corners of the store to hide the cables being run to the gondolas on the side walls. As shown in the example implementation of FIG. 11, a back view of portable store 400 is shown. In the example, reinforcement (e.g., reinforcement 1100) may be added to the wall behind the server cabinet to ensure the walls can hold the weight of the network and server equipment.

Some example advantages of the described network and network cabling system may include flexibility of network connectivity options where a fixed line may not be available, thus opening up more potential locations for the store. It manages the significant amount of cabling required for the system, ensuring it is readily accessible while hiding it away from consumer sight as much as possible. The built-in cable exit point on the rear wall enables easy connection to the ISP.

Referring again to FIG. 10, the electrical design may include a 240/120 VAC single phase main breaker load center with 200A capacity, including a separate 230V single phase fused disconnect switch. Copper ground bars may be welded to the base of the rear of the structure. 120V 20A duplex receptacles may be positioned across the store to enable power connection for all required equipment. In particular, a cluster of sockets (e.g., sockets 1000) may be located behind the server rack, sockets (e.g., sockets 1002) may be positioned midway up the walls behind each of the fridges, sockets (e.g., sockets 1004) may be positioned underneath the right-hand wall shelving gondola, and an exposed socket (e.g., socket 1006) to right of the fridges low down on the rear wall. Furthermore, there may be, e.g., five ceiling-mounted junction boxes (e.g., junction boxes 902). In the example, four are positioned at the four corners of the building and one is positioned at the mid-point of the front wall. The system is capable of connecting to and being powered by a solar panel array or a generator.

An example advantage of the electrical design is that the load center capacity is designed to support full electrical load of the building, taking into account all peripheral equipment that could be added on top of the core equipment set, a separate 230V switch supports use of a HVAC system in the store and the grounding bar position enables store to be quickly and easily grounded externally using a grounding spike. The position of the grounding bar on the rear of the store may allow the grounding spike to be hidden behind the store.

Additionally, the receptacle positions may mirror the equipment locations across the store while remaining hidden as much as possible. The receptacle low down on the rear wall may be left exposed to allow employees to plug in devices when required (e.g., vacuum cleaner). The junction box positions are designed to support the easy addition of externally mounted equipment (cables can be drawn from the boxes easily to the outside of the store), specifically external lights over each of the entry and exit doors plus one at each corner of the store if required and a lit sign positioned in the middle of the front wall (to advertise the retailer's brand).

Much of the equipment includes remote monitoring capabilities (e.g., via ASP 110). For example, in some implementations, fridges and freezers may include a self-locking mechanism and remote monitoring capabilities (freezers include both upright and chest freezer variants), lighting relay with remote control and monitoring and HVAC remote control device. These tools support being able to manage the store remotely and also support maintaining food safety in an unmanned environment. In particular, a fridge/freezer self-locking mechanism ensures that if a fridge temperature rises above a certain level, the fridges automatically lock to prevent people getting access to food which might be spoiled. Remote monitoring enables user to see current status of the equipment and provides the ability to be able to remotely switch off alarms, unlock the smart lock, etc. The lighting relay control system enables lights to be remotely turned off when desired, or a schedule to be set to automatically switch the lights on when the store is open and off when the store is closed. The HVAC remote control device allows HVAC system to be remotely monitored and controlled. A schedule can also be set to automatically adjust the target temperature of the HVAC during opening hours vs when the store is closed.

In some implementations, other equipment may include a coffee/hot drinks machine that is integrated with the autonomous system, a cold drinks dispensing machine integrated with the autonomous system and a hot food counter that is integrated with the autonomous system. In some implementations, there may also be provided dispensing equipment for age restricted products including, but not restricted to, alcohol, tobacco and lottery tickets. This equipment may be integrated with the autonomous system as well as being integrated with age verification technology such that access to product is restricted unless the shopper has gone through age and/or identity verification processes. A microwave and condiment stand may also be provided.

Although portable (and/or autonomous) stores offer several benefits, such as flexibility, cost-effectiveness, and accessibility, there may be some downsides. For example, depending on location, supplying a constant reliable source of power may be problematic. As such, these stores typically are in the form of small trailers or mobile vans. When such stores are intended for permanent or long-term retail purposes, power sourcing can become a significant limitation. Generators that run on gasoline, diesel or propane, while reasonable for use during a day and/or evening, become inconvenient and expensive over a longer period of time. This is particularly true for stores that require product refrigeration. Generators that can run for multiple days with high power output are large, heavy, and expensive. Moreover, they can be inefficient and inconvenient, as a separate power source is needed for the store itself and any other functional operation or device that may require a power source, such as vacuums or air supplies. This results in increased costs and complexity in managing multiple power sources.

In some implementations, to provide an improved power source, and to overcome the example and non-limiting disadvantages and problems of currently available solutions, the present disclosure may provide power to a portable and/or autonomous store as well as any accessory that may accompany or be attached to the store, such as vacuum cleaners, air supply lines for refilling tires, electrical vehicle (“EV”) chargers, etc. Because of the unique power demands that such accessories may bring, the power source of the present disclosure may also provide intelligent power management features for ensuring proper operation of all power consuming devices. Accordingly, there is provided a convenient and efficient solution using a single relocatable power source to power both the portable store and the EV chargers or other devices. This may, e.g., reduce the need for multiple power sources, have a significant impact on reducing overall costs, and streamline the process of powering portable stores and EV chargers, making the entire endeavor more cost-effective and efficient. In some implementations, the power system may include associated accessories, such as EV chargers, a relocatable power source configured to provide energy to the portable store and EV chargers, and a power distribution module configured to distribute the energy from the relocatable power source to the portable store and the EV chargers.

The power system may be available in numerous example configurations. In one such implementation, it may include EV chargers integrated into one of the sidewalls of the store, a relocatable power source (such as a battery pack) and a power distribution module. The store may be configured such that the relocatable power source is integral to the portable store itself. In some implementations, it may be installed on a wall, under the store as part of the floor, or on top of the store as part of the roof or ceiling. Depending on the configuration and materials used in manufacturing the store, the power source may be used to provide stability to the construction. For example, the power source may be constructed such that it forms one of the walls of the store. In an alternate configuration, the store structure may be formed so as to enable the battery to be installed and then moved as necessary into any of the walls, ceiling or floor. Regardless of location of the battery pack (or other power source), the power distribution module (e.g., via ASP 110) may ensure that any component requiring power will receive the correct levels of power and may be monitored for a variety of operating conditions.

In some implementations, the EV chargers may be remotely located and placed a distance away from the store itself. In such a layout, the EV chargers may continue to receive their power from the battery pack located in the store. In some implementations, the battery pack may be physically located with the EV chargers but also be used to power the store. Similarly, the power distribution module (e.g., via ASP 110) may be located with the EV chargers but continue to monitor the entire installation to ensure power is supplied to all devices as appropriate.

In some implementations, the power supply, which may be a battery or other power source, may be located remotely from the EV chargers and the store, regardless of whether the EV chargers are integrated with the store. In such a configuration, the power source supplies power to the EV chargers and store, with the power distribution module (e.g., via ASP 110) once again ensuring the various power consuming devices are being properly monitored and receiving the correct amount of power.

As noted above, the power distribution module (e.g., via ASP 110) may be used for a variety of functions, including monitoring and regulating power distribution to the various power consuming devices. The power distribution module may use a complementary mix of hardware and software (e.g., as available from Sparkion, a Vontier Corporation company) to provide onsite energy management for ensuring energy is continuously available even when simultaneous power consumption increases. In addition, the power distribution module (e.g., via ASP 110) may use artificial intelligence and machine learning to monitor the performance and power consumption of the devices and the system as a whole. Based on such monitoring, the power distribution module (e.g., via ASP 110) may learn the usage pattern of the site. ASP 110 may use that data as well as other real-time site data to optimize operation. In some implementations, such data may be transmitted and stored locally and/or remotely for processing and control.

It will be appreciated after reading the present disclosure that the power system described herein is not necessarily limited to a single power source. For instance, in the absence of a correctly sized single power source, one or more additional sources of power may be used. These additional sources may be of different types or multiples of the same source type. In such cases, the power distribution module (e.g., via ASP 110) once again may properly ensure the various power consuming devices are being properly monitored and receiving the correct amount of power as appropriate from the multiple power sources.

### The Autonomous Store Process:

As discussed above and referring also at least to the example implementations of FIGS. 3-14, Autonomous Store Process (ASP) 110 may track 1200, by a computing device, at least one user within an autonomous environment. ASP 110 may determine 1202 that the at least one user has taken an object from a first location and placed it in a second location. ASP 110 may add 1204 an object ID of the object to a data container based upon, at least in part, determining that the at least one user has taken the object from the first location and placed it in the second location. ASP 110 may detect 1206 that the at least one user has entered a predefined area while the object ID is in the data container. ASP 110 may initiate 1208 checkout for the at least one user to provide an amount equal to a total charge for the object based upon, at least in part, detecting that the at least one user has entered the predefined area while the object ID is in the data.

In some implementations, ASP 110 may track 1200, by a computing device, at least one user within an autonomous environment. For instance, assume for example purposes only that a user (e.g., user 150) is approaching portable store 400. As noted above, when user 150 approaches the store, the doors may be in a closed and locked state. To enter the store, user 150 may use door entry system 500 (from FIG. 5). For purposes of this example, assume that user 150 taps a credit card on payment device 502. During this particular interaction, door entry system 500 (e.g., via ASP 110) decides whether the card is acceptable. If not, the door remains locked, and the user may be prompted to try again. Now assume that the card is accepted and user 150 enters portable store 400, where ASP 110 may begin tracking user 150. It will be appreciated after reading the present disclosure that user 150 may begin to be tracked prior to entering portable store 400, such as when attempting to enter the store using door entry system 500.

In some implementations, ASP 110 may use data combined from one or more sources to help track user 150. For instance, ASP 110 may use visual sources such as lidar, planogram, cameras, or other type of functionally similar devices to identify someone as a unique person, and distinguish them from others. ASP 110 may use such things as facial recognition (e.g., to either identify or at least distinguish one person from another), movement/trajectory tracking algorithms, voice prints, or other biometrics for tracking techniques.

For instance, ASP 110 may use Wi-Fi tracking, which utilizes the strength of Wi-Fi signals and the MAC addresses of mobile devices to triangulate the position of individuals within a building. ASP 110 may analyze the signal strength from multiple Wi-Fi access points to determine a device's (and therefore the user's) location. As another example, ASP 110 may use Bluetooth Low Energy (BLE) Beacons, which are small devices that broadcast their identifier to nearby portable electronic devices. The technology enables smartphones, tablets, and other devices to perform actions when in close proximity to a beacon. BLE may also be used in retail environments to improve customer experience by sending targeted advertisements or notifications. As another example, ASP 110 may use RFID (Radio Frequency Identification), which uses electromagnetic fields to automatically identify and track tags attached to objects, including ID cards carried by people. RFID may be used for access control, tracking user movement, and enhancing security protocols within portable store 400. As another example, ASP 110 may use UWB (Ultra-Wideband), which provides precise, real-time location tracking by measuring the time that it takes for a radio wave to travel from a tag to several receivers. As another example, ASP 110 may use infrared sensors for counting people and monitoring movement directions within a building. Infrared sensors detect body heat to track presence and movement but generally provide less specific positional data compared to other technologies. As another example, ASP 110 may use Computer Vision and Video Analytics, which utilizes camera feeds combined with AI and machine learning algorithms to identify and track individuals' movements within a location. ASP 110 may use this to analyze video in real-time to count people, track movements, and even identify specific behaviors. As another example, ASP 110 may use GPS combined with indoor tracking technologies for comprehensive coverage. As another example, ASP 110 may use geofencing, which may include a combination of GPS, RFID, Wi-Fi, or cellular data to create a virtual boundary around a geographical location. When a device enters or leaves this area, it triggers a pre-defined action, which can be used for attendance, security alerts, or to push notifications.

In some implementations, tracking the at least one user within the autonomous environment may include assigning 1210 a user ID to the at least one user. For instance, assume for example purposes only that user 150 has been authorized to enter portable store 400 and is now being tracked by ASP 110. In the example, ASP 110 may assign an identifier (ID), such as a payment token identifier (ID) to user 150. In some implementations, ASP 110 may save the payment token ID and may generate a unique session ID (USID) that indicates user 150 has been approved. In some implementations, either payment token ID and/or the USID may be assigned to user 150 (e.g., via I/O 115).

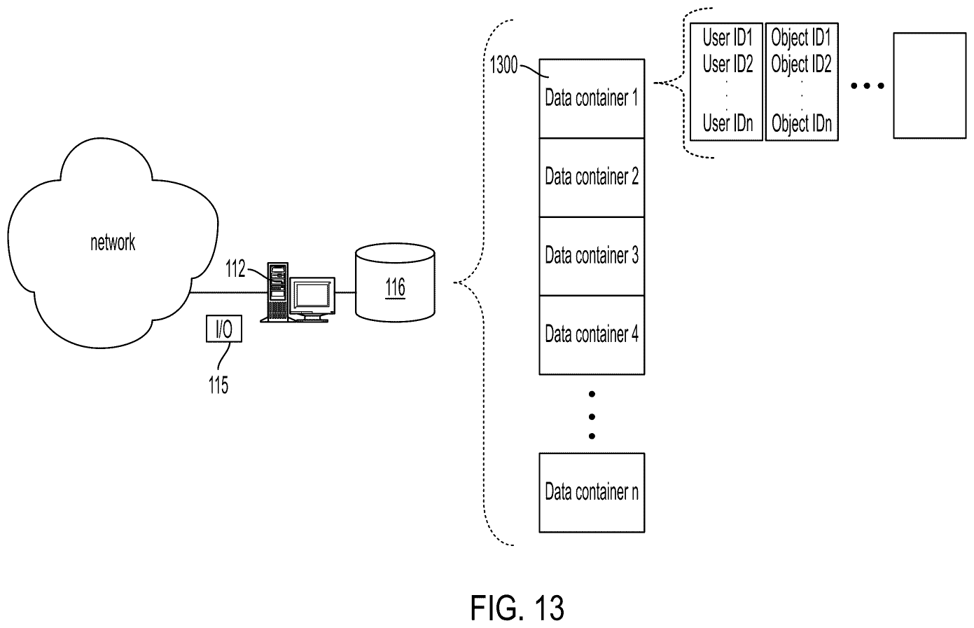

In some implementations, ASP 110 may assign 1212 the user ID to the data container. For instance, and referring at least to the example implementation of FIG. 13, an example data storage layout is shown. Assume for example purposes only that when user 150 is assigned a user ID, that ASP 110 also assigns user 150 to a data container (e.g., a virtual basket). The data container (e.g., data container 1300) may include any number of data points that may be associated with user 150, including the above-noted user ID, the data container ID, as well as one or more object IDs (described further below). It will be appreciated after reading the present disclosure that there may be various other ways to assign different IDs to user 150 and data container 1300. For instance, ASP 110 may use the USID as a key to generate a virtual basket ID and may assign the USID to the virtual basket ID, such that the USID is linked to the virtual basket ID.

In some implementations, ASP 110 may determine 1202 that the at least one user has taken an object from a first location and placed it in a second location. For instance, ASP 110 may determine that user 150 has taken an object (e.g., shampoo) from a first location (e.g., on a shelf) and placed it in a second location (e.g., their shopping cart or any location other than the first location) because user 150 will later purchase the shampoo.

In some implementations, determining that the at least one user has taken the object from the first location and placed it in the second location may include identifying 1214 a change to a surface of the first location. For instance, as noted above, portable store 400 may include multiple cameras, taking images of the first location. ASP 110 may compare two different images of the first location to determine whether the object has moved a sufficient amount to be considered as having been taken by user 150, or simply picked up and put back in the same or slightly different location (e.g., by a few inches). It will be appreciated that other techniques, taken singly or in any combination, may also be used to determine whether user 150 has taken the shampoo. For instance, any of the techniques used to track user 150 (e.g., RFID, etc.) may similarly be used to determine whether user 150 has taken the shampoo. As another example, weight sensors may be used to determine whether user 150 has taken the shampoo (e.g., if the sensor was at a certain weight, but now has less weight for a predetermined amount of time, it may be determined that user 150 has taken the shampoo). In some implementations, ASP 110 may have access to a data store with the known weights of each product. In some implementations, the weight sensor may also be used to determine whether a user is attempting to defraud the store by replacing a new bottle of shampoo with a used bottle of shampoo, which may also include a camera showing the same or similar bottle of shampoo having been picked up and put down. In some implementations, the weight sensor may also be used to determine whether a user is attempting to defraud the store by pickup up multiple shampoo bottles, but only placing one shampoo bottle back on the shelf, as an attempt to trick the cameras into thinking one shampoo bottle was picked up and one was put back, when in actuality two were picked up and only one was put back.

In some implementations, determining that the at least one user has taken the object from the first location and placed it in the second location may further include determining 1216 that a confidence level for identifying the object meets a predetermined threshold. For instance, using any of techniques noted above, ASP 110 may determine a confidence score about whether user 150 has picked up the shampoo from the shelf and placed it in their shopping cart. As an example, there may be a confidence level based on the weight sensor for whether user 150 has picked up the shampoo from the shelf and placed it in their shopping cart. As another example, there may be a confidence level based on comparing two images (e.g., before the shampoo was moved and after) as to whether user 150 has picked up the shampoo from the shelf and placed it in their shopping cart. As yet another example, there may be a confidence level based on whether the known image of the shampoo matches the item that user 150 has picked up from the shelf and placed it in their shopping cart. In some implementations, each metric used may have its own confidence level, which when combined, may generate a final confidence level as to whether user 150 has picked up the shampoo from the shelf and placed it in their shopping cart. For instance, if the final confidence level is below a predetermined confidence threshold, then ASP 110 may determine that user 150 did not put the shampoo in their shopping cart, but rather placed the shampoo back on the shelf (first location). On the other hand, if the final confidence level is above a predetermined confidence threshold, then ASP 110 may determine that user did put the shampoo in their shopping cart (second location), rather than? placed the shampoo back on the shelf (first location). In some implementations, ASP 110 may determine that any one of the confidence levels by themselves may be dispositive for or against determining that user 150 has picked up the shampoo from the shelf and placed it in their shopping cart. It will be appreciated after reading the present disclosure that the confidence level may similarly be used to determine fraud, as noted above.

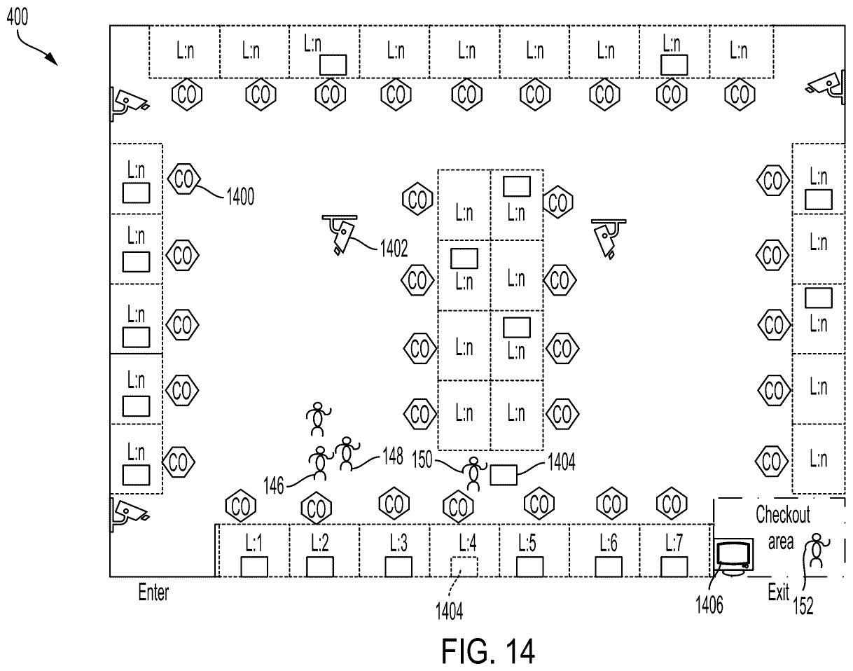

In some implementations, determining that the at least one user has taken the object from the first location and placed it in the second location may further include determining 1218 that the user ID assigned to the at least one user is closest to the first location when the change to the surface of the first location is identified. For instance, and referring at least to the example implementation of FIG. 14, an example top view of portable store 400 is shown. In the example, as noted above, portable store 400 may include multiple sensors (e.g., sensors 1400, such as weight sensors, location sensors, etc. described throughout) and audio/video sensors (e.g., cameras 1402, such as infrared, etc. discussed throughout). Assume for example purposes only that the data from sensors 1400 and/or cameras 1402 (e.g., via ASP 110) are able to determine the location of user 150 relative to the shampoo or other location within the store. Further assume for example purposes only that the shampoo (e.g., shampoo 1404) is in location L:4, and further assume that user 150 is closest to location L:4 at the time ASP 110 determines that user 150 has taken shampoo 1404 and placed it in their shopping cart. In the example, as ASP 110 has determined that user 150 and shampoo 1404 were closest to L:4 when shampoo 1404 was determined to have been moved, ASP 110 may determine that user 150 is the one that has moved shampoo 1404.

In some implementations, ASP 110 may add 1204 an object ID of the object to a data container based upon, at least in part, determining that the at least one user has taken the object from the first location and placed it in the second location. For instance, assume for example purposes only that ASP 110 identifies shampoo 1404 by its own unique ID (e.g., object ID). In the example, having determined that user 150 has placed the shampoo in their shopping cart, ASP 110 may add the object ID for shampoo 1404 to the data container of user 150 (from FIG. 13). In some implementations, object ID may include information about the shampoo including, e.g., universal product code (UPC), cost, location in the store, etc. Conversely, if it is determined that user 150 has later placed the shampoo back in the first location (or similarly close location such that it is determined to no longer be in the shopping cart of user 150), ASP 110 may remove the object ID for shampoo 1404 from the data container of user 150.

In some implementations, ASP 110 may detect 1206 that the at least one user has entered a predefined area while the object ID is in the data container. For instance, using any of the above-noted tracking techniques, ASP 110 may detect that user 150 has entered a predefined area (e.g., a checkout area). In the example, assuming the object ID for the shampoo is still in the data container of user 150, this may be indicative that user 150 wants to pay for the shampoo and exit the store. It will be appreciated after reading the present disclosure that the predefined area may be outside the store. In some implementations, crossing the threshold of the store may also be considered the predefined area.

In some implementations, ASP 110 may initiate 1208 checkout for the at least one user to provide an amount equal to a total charge for the object based upon, at least in part, detecting that the at least one user has entered the predefined area while the object ID is in the data. For instance, having determined that user 150 is at the predefined area (e.g., checkout area) while the object ID for shampoo is in the data container of user 150, ASP 110 may initiate the process for user 150 to pay for the shampoo. It will be appreciated after reading the present disclosure that any number of products may be identified by various object IDs, which may then be paid for using any known payment methods. For example, assume that 10 object IDs were in the data container of user 150 when entering the checkout area. In the example, ASP 110 may initiate the process for user 150 to pay for each product associated with its respective object ID.

In some implementations, the checkout section provides a physical interface through which the shopper may interact with the store and the checkout process. This may include a touch screen and printer, and optionally an NFC/RFID reader, 2D scanner, fingerprint sensor, status, EMV bracket and other functional and aesthetic features. The screen displays the products that were picked up by the consumer, as identified by ASP 110 as having a high confidence level as well as the total amount of products in the basket. In some implementations, the touch screen (e.g., via ASP 110) may provide an optional physical interface to the shopper. For example, the shopper's phone number may be collected if a receipt is wanted. Consumer feedback on the shopper's journey may also be collected. Consumer disputes may also be entered through the screen, such as if there is a mistake in the basket and any relevant comments or reasons for the error. The screen is also able to notify the shopper there is a problem with the accuracy level and that a human will contact them. Still another optional feature includes the ability for the consumer to add loyalty information to receive discounts and earn loyalty points based on their existing program. Many other types of information may be provided, such as notifying the shopper that the system detected that nothing was taken, although the shopper still reached the checkout area.

In some implementations, assigning the user ID to the at least one user may include, when the at least one user includes two or more users, assigning 1220 a first unique user ID to a first user of the two or more users, assigning 1222 a second unique user ID to a second user of the two or more users, and assigning 1224 the first unique user ID and the second unique user ID to the data container. For instance, assume for example purposes only that a married couple has entered the store together as a group, such that there is more than a single shopper. In the example, similarly to the discussion above, ASP 110 may assign a USID to the first user (e.g., user 146), assign a second USID for the second user (e.g., user 148), and may assign both the first USID and the second USID to the same (joint) data container. As a result, whether ASP 110 determines that user 146 has picked up an item and placed it in their shopping cart, or whether ASP 110 determines that user 148 has picked up an item and placed it in their shopping cart, the respective object ID will be placed in their joint data container. In some implementations, just like there were multiple example confidence levels to determine whether user 150 placed the shampoo in their shopping cart, ASP 110 may use one or more confidence levels to determine whether two or more shoppers are part of a group, such that their USIDs should be associated with the same data container. For instance, ASP 110 may use the above-noted sensors and/or tracking techniques to identify certain traits indicative that two or more people are in a group. As an example, whether or not user 146 and user 148 came in together or separately. As another example, whether or not user 146 and user 148 continuously meet up within the store, or talk to each other, or express mannerism indicating they know each other (e.g., holding hands, hugging, etc.), their predicted age (e.g., are they kids with their caretaker), whether each user has their own shopping basket, how long between user 146 and user 148 entered the store, was the door was closed or open between the time that user 146 entered and user 148 entered, whether user 146 is passing products to user 148 or leaving together within a certain amount of time, etc.

In some implementations, each metric used may have its own confidence level, which when combined, may generate a final confidence level as to whether user 146 and 148 should be considered as a group. For instance, if the final confidence level is below a predetermined confidence threshold, then ASP 110 may determine that user 146 and 148 are not a group for purposes of combining their USIDs to a single joint data container. On the other hand, if the final confidence level is above a predetermined confidence threshold, then ASP 110 may determine that users 146 and 148 are a group for purposes of combining their USIDs to a single joint data container.

It will be appreciated after reading the present disclosure that while consumer products are described as being purchased, other products may be purchased as well. For instance, the present disclosure may be used for purchasing fuel, vehicles, etc. In such instances, the shopper may be identified and authenticated as described above, but in this case, the shopper may be located at a dispenser or charging station attached to or adjacent to the store. Once the shopper is identified, the dispenser/charger may be authorized to dispense fuel or provide a charge. Alternatively, the shopper may also purchase a predetermined amount of fuel/charge inside the store and then simply walk to the dispenser/charger and begin fueling/charging. As such, the use of consumer products should be taken as example only and not to otherwise limit the scope of the present disclosure.

In some implementations, the checkout area may include a display (e.g., display 1406), which may enable users to see their shopping cart contents and enter any personal or additional information as needed, which may not be already stored in their store profile. In some implementations, once one of the group shoppers has confirmed the contents of their shopping cart and after the last person in the party leaves the store, payment may be completed. In some implementations, ASP 110 may decide whether the USID(s) assigned to the data container being checked out meets an accuracy threshold (e.g., is the shopper leaving the store with items identified the same as the shopper assigned to the data container to be checked out). If it does not, an alert may be raised in the Human in the Loop Component for a live person to review the situation. However, if the identification is approved, ASP 110 may then check to see if the entire group of shoppers has left by determining whether any of the group members are still in the store as evidenced by whether any additional USIDs with the same data container. If so, ASP 110 may continue to track the USIDs. However, if no group members are detected, ASP 110 may wait a predetermined amount of time and then consolidates all the individual USIDs to the same data container.

In some implementations, once it is determined that the group of shoppers has left the store, ASP 110 may receive that information and transmit it to a selling engine. There, the balance due may be calculated and the transaction may be created. That information may then be received by ASP 110, which may then locate the payment token noted above. The payment may then be performed and the transaction with the final amount may be settled. As with the single shopper journey, approval may then be sent to and received by ASP 110 to finalize the transaction with payment details and generate a receipt, which may then be received by ASP 110. The receipt may then be matched to the data container ID and personal information, such as phone number or email address. Subsequently, ASP 110 may generate a message, such as SMS or email with a link to the receipt and send the receipt to the shopper.

In some implementations, the ability to create a bridge between a human shopper and an AI system, enabling the shopper to view their shopping cart that is calculated by the AI system of ASP 110 may be invaluable. In some implementations, the shopper can also dispute the shopping cart if they believe there are any mistakes, provide loyalty details, provide details for receiving the receipt, providing feedback, etc.

In some implementations, ASP 110 may increase accuracy of product detection, create structured workflows for autonomous journeys, track people and products, and improve the training of artificial intelligence (“AI”) functionality. ASP 110 may implement a dynamic virtual shopping bag system (e.g., data container), a middleware component for creating structured workflows for autonomous journeys, a tracking system for people and products, and an image generating system for product recognition.

One of the example problems faced in autonomous and cashierless stores is the lack of confidence and accuracy in autonomous environments for shoppers in confirming and verifying the detection of products that have been picked up. This leads to confusion and mistrust in the system's ability to correctly identify and charge for the products taken. To overcome these disadvantages, ASP 110 provides, as discussed throughout, a virtual shopping bag to impart an efficient and convenient shopping experience for anonymous users by tracking the products taken and presenting the information only within a defined checkout area, ensuring privacy. In some implementations, the virtual shopping bag system includes a recognition module that solves this problem by giving shoppers the ability to view and approve the system's evaluation of the products picked up and taken, thereby increasing their confidence and accuracy in the process. The shopper may review the contents of the shopping basket at any time during the shopping process to check for changes that may be occurring in the basket. This ensures the shopper is charged only for the products actually taken and that there is transparency in the process. In addition, the system provides an efficient and convenient shopping experience for anonymous users, ensuring privacy by presenting information only within the defined checkout area and clearing the information once the user has left the area. The virtual shopping bag may include people, recognition objects, product recognitions, virtual shopping cart, cloud management, checkout module (screen) and checkout area object detection.

Another issue faced by autonomous and cashierless stores is the difficulty in creating structured workflows for autonomous journeys in a seamless and efficient manner. This leads to a fragmented and disjointed experience for users. To obviate such issues, ASP 110 provides a workflow-based middleware component (“Retail Component”), an API based communication layer, a journey builder module and a frictionless environment. More particularly, the middleware component provides a platform that enables the creation of structured workflows for autonomous journeys in a frictionless environment. The component includes a communication interface for receiving and transmitting data between multiple components via APIs, a journey builder module for structuring a series of connected components into a defined workflow, and a journey controller module for monitoring and controlling the flow of the journey. This allows for a seamless and efficient experience for users, improving the overall quality of autonomous journeys.

Autonomous stores may benefit from a comprehensive and accurate solution for tracking people and products in an autonomous environment. This information is valuable for gaining insights into their movements and behaviors. However, current solutions are insufficient in providing accurate and comprehensive tracking data. ASP 110 may help solve this problem by combining data from multiple sources, such as a lidar module, planogram module, camera module, or other type of functionally similar device, through an integration module of ASP 110. It further includes object recognition and a virtual shopping cart integration module. This results in a high accuracy identification of an autonomous journey for a tracked person, providing valuable insights into their movements and behaviors in the autonomous environment by combining data from multiple sources.

The AI abilities used in product recognition should be extremely accurate to help address some of the issues noted above. Unfortunately, the difficulty in efficiently and effectively training AI object detection modules is a problem. The process of collecting and pre-processing data, annotating and labeling images, and training the AI module requires significant time and resources, and is dependent on the quality of the data used. To provide a solution that can provide large amounts of high-quality data and images to train the AI module, based on a single image or data element, ASP 110 provides a product recognition module that enhances the ability of the AI to accurately recognize products by providing a diverse set of images for training. As such, it improves the overall performance of the system in identifying products when picked up by a consumer by generating a diverse set of images for the AI product recognition module to train on.

ASP 110 may include an onboarding device with a managed onboarding module, a generation module, an output interface and a product recognition module. The product may be placed inside the onboarding device, the onboarding device including for example a set of cameras capturing a vertical side (e.g., 75-90 degree) image and a top (e.g., 20-45 degree) angle facing down image, the product is placed on a rotating device, similar to an electronic turntable, the onboarding module receives as an input the products parameters, like name, barcode, etc. The generation module of ASP 110 may generates multiple images of the same product in different angles and lighting poses. The output interface of ASP 110 may feed the generated images into the AI product recognition module of ASP 110 for training purposes. The product recognition module of ASP 110 may identify products in an autonomous environment. Thus, it can be seen that the module enhances the ability of the AI product recognition module to accurately recognize products by providing a diverse set of images for training, improving the overall performance of the system in identifying products when picked up by a consumer.

In some implementations, ASP 110 may, within a predefined (relative) short amount of time (e.g., 30 sec), generate an “AI kit” that enables an AI model to be trained on this data and identify in high accuracy the product presented to the model.

The process of ASP 110 for the onboarding may include, e.g.:

Data Capturing setup—the onboarding is conducted in an environment that has control over lighting, reflections from the surrounding walls (usually to control all the environmental parameters, using a box, that is prepared with white/black internal padding, it consists of a turntable component, lighting and cameras, it may contains additional devices like turntable that incorporates weight or sensors for additional data point capturing).

Data Capturing—During the onboarding process the system generates more than 1K images of the product in various angles (e.g., 90 degree, 45 degrees etc.). It collects additional information on the product (like barcode, weight, dimensions, etc.), and captures “text labels” on the product, colors etc. All the data-set consists of images, and textual data, weight, dimensions, product name, category type and more. All the data is stored in a structured file in a data store, and ASP 110 is able to add manual information that is captured by the person performing the onboarding process.

Post processing cleaning-part of this step there is a cleanup process, images that have some occlusion are being removed, to achieve a high resolution and high-quality data set. Renaming of the files is being done to reflect the product details and camera angle and additional parameters in the file name.

Upload dataset—all the data is being zipped and upload to a cloud component for storage and additional post processing (augmentation etc.).

Record Dataset—the uploaded zip file is being extracted and converted to a structed file, the system documents every step of the onboarding and consists of links to all images folders and consists of all the product's information. In addition, all the data is stored in a cloud data store and images stored in a cloud storage system. The tracking enables 3rd party integrations and enables ASP 110 to raise notification on the progress of onboarding a new product.

Annotation Process—the data set (images) is loaded into an annotation platform that annotates each image and generates a file (a file format that is used for different augmentation systems as an input file).

Augmentation process—all the images and annotation file are loaded into an augmentation platform that generates based on the selected augmentation methods additional multiple images which creates a larger set of data set for the model to identify the product in many scenarios and different situations and achieve high accuracy.

3D model of the product—all these images plus collective data enables the system to generate a 3D model of the product and can be simulated in any environment.

Model Training—all the data set is then pushed to the model for incremental training, at the end of the process there is a model ready to be used to classify products in different positions.

Regarding a retail workflow component of ASP 110, it enables the system to readjust the shopper's journey when needed and reroute the next step or outcome, and also enables to reroute messages and indications to the Customer (e.g., the system's owner).

System structure and vision—this portion of ASP 110 is conceived by multiple components, each component has its role and responsibilities, and that component received and input and generates an output based on its role and actions it is responsible for. The Retail (Workflow) component of ASP 110 is responsible for orchestrating all the workflow and passes the messages from one component to the other, with the ability to add data to one of the components output and push it as an input to another component.

System components—this portion of ASP 110 has many components, but not exclusive to these only: check-in component, payment component, tracking component, virtual basket component, selling engine, receipt component, checkout component, etc.

Shopper's advantage—since ASP 110 is very flexible it can incorporate different workflows based on the Customer demand or the shopper preference. for example:

ASP 110 may develop an auditable component that is responsible for generating sound within the store.

The shopper may request to update their profile with their Spotify favorite list and once identifying with a mobile app and entering the store, their favorite play list will start running as the store's background music.

The customer may request that once a shopper enters they will be welcomed with a “welcoming” message and “what's on sale today” will be called out.

### Another Example

ASP 110 may develop a push notification for promotions to shoppers.

The shopper enters with a mobile app will get immediate list of everything that is on sale and they are eligible to receive in this shopping journey.

The Customer may want to push nearly expired products to reduce waste and leverage this system to push targeted promotions to shoppers entering the store based on their previous shipping habits.

Customer's advantage (in addition to the previous description)—the customer can gain many additional backend advantages by integrating additional components without impacting the overall journey (by building a new workflow). They can have stores that do not have a checkout component, the shopper can skip that part of the journey in that specific store. The store can be in an office building where the customer is funding the products to the employees. This reduces the need for a check-in component and a payment component. The customer may decide in the future to incorporate cleaning robots in the store, once the Retail (workflow) component identifies no one is in the store ASP 110 can trigger for a robot to initiate the self-cleaning action and have the robot clean the store without impacting the shoppers journey, providing always a cleaned environment. Some products being sold may create inventory gaps on the shelves, and this can be automated, by sending on-the-fly or daily inventory reports to the customer's backend inventory systems to generate an inventory delivery of the missing products.

It will be appreciated after reading the present disclosure that any implementations disclosed in the portable store may be used in combination with any implementations disclosed in the autonomous store. Similarly, it will be appreciated after reading the present disclosure that any implementations disclosed in the autonomous store may be used in combination with any implementations disclosed in the portable store. As such, any implementation described only in the portable store section should not be taken as excluding such an implementation from autonomous store implementations, and any implementation described only in the autonomous store section should not be taken as excluding such an implementation from portable store implementations.

The terminology used herein is for the purpose of describing particular implementations only and is not intended to be limiting of the disclosure. As used herein, the singular forms “a”, “an” and “the” are intended to include the plural forms as well, including any steps performed by a/the computer/processor, unless the context clearly indicates otherwise. As used herein, the phrase “at least one of A, B, and C” should be construed to mean a logical (A OR B OR C), using a non-exclusive logical OR, and should not be construed to mean “at least one of A, at least one of B, and at least one of C.” As another example, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof. Example sizes/models/values/ranges can have been given, although examples are not limited to the same.

The terms (and those similar to) “coupled,” “attached,” “connected,” “adjoining,” “transmitting,” “receiving,” “connected,” “engaged,” “adjacent,” “next to,” “on top of,” “above,” “below,” “abutting,” and “disposed,” used herein is to refer to any type of relationship, direct or indirect, between the components in question, and is to apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action is to occur, either in a direct or indirect manner. The term “set” does not necessarily exclude the empty set—in other words, in some circumstances a “set” may have zero elements. The term “non-empty set” may be used to indicate exclusion of the empty set—that is, a non-empty set must have one or more elements, but this term need not be specifically used. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The corresponding structures, materials, acts, and equivalents (e.g., of all means or step plus function elements) that may be in the claims below are intended to include any structure, material, or act for performing the function in combination with other claimed elements as specifically claimed. While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited. While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure. Moreover, although this disclosure describes and depicts respective implementations herein as including particular components, elements, feature, functions, operations, or steps (and arrangements thereof), any of these implementations (including any implementations from either the portable store and/or autonomous store implementations) may include any combination, arrangement, or permutation of any of the components, elements, features, functions, operations, or steps described or depicted anywhere herein that a person having ordinary skill in the art would comprehend after reading the present disclosure. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The description of the present disclosure has been presented for purposes of illustration and description but is not intended to be exhaustive or limited to the disclosure in the form disclosed. After reading the present disclosure, many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A portable building structure comprising:
a portable building structure, including:
a plurality of interior attachment points, wherein the plurality of interior attachment points includes:
a first portion of the plurality of interior attachment points configured to secure equipment to an interior portion of the portable building structure when the equipment is in use;
a second portion of the plurality of interior attachment points configured to further secure the equipment to the interior portion of the portable building structure during transportation of the portable building structure;
a plurality of exterior attachment points, wherein the plurality of exterior attachment points includes:
a first portion of the plurality of exterior attachment points configured to enable the portable building structure to be lifted off a ground surface prior to transportation;
a second portion of the plurality of exterior attachment points configured to enable the portable building structure to be secured to a vehicle for transportation; and
a computing device configured to track at least one user within the portable building structure, wherein the computing device is further configured to determine whether the at least one user has taken an object from a first location within the portable building structure and placed it in a second location within the portable building structure.

2. The portable building structure of claim 1, wherein the first portion of the plurality of interior attachment points configured to secure the equipment to the interior portion of the portable building structure when the equipment is in use includes at least one of a plurality of barriers extending from at least one wall of the portable building structure and at least one channel securing a portion of the equipment to the at least one wall of the portable building structure.

3. The portable building structure of claim 1, wherein the second portion of the plurality of interior attachment points configured to further secure the equipment to the interior portion of the portable building structure during transportation of the portable building structure includes at least one channel securing a portion of the equipment to at least one wall of the portable building structure.

4. The portable building structure of claim 1, wherein the first portion of the plurality of exterior attachment points configured to enable the portable building structure to be lifted off the ground surface prior to transportation includes one or more lift attachments.

5. The portable building structure of claim 1, wherein the second portion of the plurality of exterior attachment points configured to enable the portable building structure to be secured to the vehicle for transportation includes one or more rings.

6. The portable building structure of claim 5, wherein the one or more rings enable the portable building structure to be secured to the vehicle for transportation without extending beyond a perimeter of the portable building structure.

7. The portable building structure of claim 1 further comprising one or more interior channels for receiving electrical wiring, wherein the one or more interior channels are coupled to a front frame of the portable building structure.

8. A portable building structure comprising:
a portable building structure, including:
a plurality of interior attachment points, wherein the plurality of interior attachment points includes:
a first portion of the plurality of interior attachment points configured to secure equipment to an interior portion of the portable building structure when the equipment is in use;
a second portion of the plurality of interior attachment points configured to further secure the equipment to the interior portion of the portable building structure during transportation of the portable building structure, wherein the second portion of the plurality of interior attachment points configured to further secure the equipment to the interior portion of the portable building structure during transportation of the portable building structure includes at least one channel securing a portion of the equipment to at least one wall of the portable building structure;
a plurality of exterior attachment points, wherein the plurality of exterior attachment points includes:
a first portion of the plurality of exterior attachment points configured to enable the portable building structure to be lifted off a ground surface prior to transportation; and
a second portion of the plurality of exterior attachment points configured to enable the portable building structure to be secured to a vehicle for transportation.

9. The portable building structure of claim 8, wherein the first portion of the plurality of interior attachment points configured to secure the equipment to the interior portion of the portable building structure when the equipment is in use includes at least one of a plurality of barriers extending from at least one wall of the portable building structure and at least one channel securing a portion of the equipment to the at least one wall of the portable building structure.

10. The portable building structure of claim 8 further comprising a computing device configured to track at least one user within the portable building structure, wherein the computing device is further configured to determine whether the at least one user has taken an object from a first location within the portable building structure and placed it in a second location within the portable building structure.

11. The portable building structure of claim 8, wherein the first portion of the plurality of exterior attachment points configured to enable the portable building structure to be lifted off the ground surface prior to transportation includes one or more lift attachments.

12. The portable building structure of claim 8, wherein the second portion of the plurality of exterior attachment points configured to enable the portable building structure to be secured to the vehicle for transportation includes one or more rings.

13. The portable building structure of claim 12, wherein the one or more rings enable the portable building structure to be secured to the vehicle for transportation without extending beyond a perimeter of the portable building structure.

14. The portable building structure of claim 8 further comprising one or more interior channels for receiving electrical wiring, wherein the one or more interior channels are coupled to a front frame of the portable building structure.

15. A method comprising:
securing, using a first portion of a plurality of interior attachment points, equipment to an interior portion of a portable building structure;
securing, using a second portion of the plurality of interior attachment points, the equipment to the interior portion of the portable building structure for transportation of the portable building structure;
installing a computing device tracking system to track at least one user within the portable building structure and to determine whether the at least one user has taken an object from a first location within the portable building structure and placed it in a second location within the portable building structure;
lifting, using a first portion of a plurality of exterior attachment points, the portable building structure off a ground surface prior to transportation; and
securing, using a second portion of a plurality of exterior attachment points, the portable building structure to a vehicle for transportation.

16. The method of claim 15, wherein securing the equipment to the interior portion of the portable building structure includes securing the equipment to the interior portion of the portable building structure using at least one of a plurality of barriers extending from at least one wall of the portable building structure and at least one channel securing a portion of the equipment to the at least one wall of the portable building structure.

17. The method of claim 15 further comprising enabling, using one or more lift attachments, the portable building structure to be lifted off the ground surface prior to transportation.

18. The method of claim 15, wherein securing the equipment to the interior portion of the portable building structure for transportation of the portable building structure includes securing, using at least one channel, a portion of the equipment to at least one wall of the portable building structure.

19. The method of claim 15 further comprising securing, using one or more rings of the second portion of the plurality of exterior attachment points, the portable building structure to the vehicle for transportation.

20. The method of claim 19, wherein the one or more rings enable the portable building structure to be secured to the vehicle for transportation without extending beyond a perimeter of the portable building structure.

21. The method of claim 15 further comprising coupling, to a front frame of the portable building structure, one or more interior channels for receiving electrical wiring.
